(19) United States
(12) Patent Application Publication
(10) Pub. No.: US 2007/0027579 A1
(43) Pub. Date: Feb. 1, 2007

(54) Mobile robot and a mobile robot control method

(75) Inventors: Kaoru Suzuki, Kanagawa-ken (JP); Toshiyuki Koga, Kanagawa-ken (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 11/396,653

(22) Filed: Apr. 4, 2006

(30) Foreign Application Priority Data
Jun. 13, 2005 (JP) 2005-172855

(51) Int. Cl. G06F 19/00

(52) U.S. Cl. 700/245

(57) ABSTRACT

In a mobile robot, a user position data acquisition unit acquires user position data representing a user's location. A user movable space generation unit generates user movable space data representing a space in which the user moves based on the user position data. A position relationship control unit controls a position relationship between the user and the mobile robot based on the user movable space data.

### CROSS-REFERENCE TO RELATED APPLICATIONS

This application is based upon and claims the benefit of priority from prior Japanese Patent Application No. 2005-172855, filed on Jun. 13, 2005; the entire contents of which are incorporated herein by reference.

### FIELD OF THE INVENTION

The present invention relates to a mobile robot and a mobile robot control method for searching for and tracking a user in a movable space.

### BACKGROUND OF THE INVENTION

Recently, various robots share an activity space with a human. The robot may track a user and observe whether the user is safe. For example, in case that a user lives alone in house, even if some unusual event occurs, the user cannot always connect with another person. In this case, when a robot detects the user's unusual situation, by immediately connecting with an observation center, the user's safety can be maintained. In order to cope with above-mentioned use, the robot should have at least two functions, i.e., a function to search/track a user and a function to detect the user's abnormality.

As the function to search for and track the user, the robot moves within a space to a user's position and uses map data of the space to search for the user. Up to this time, two kinds of usable map data exist as a work space map and a network map.

The work space map is, for example, a map describing geometrical information of a robot's movable space. In detail, a robot analyzes a shape of the movable space, and creates a moving path satisfied with a predetermined condition as the workspace map. By following the moving path, the robot can move in a movable space.

Furthermore, in case of detecting unknown obstacle in a movable space by a sensor, by adding the obstacle to the map data and recreating a moving path, technique applicable to obstacle avoidance is proposed. (For example, Japanese Patent Disclosure (Kokai) 2001-154706 (citation 1), and Japanese Patent Disclosure (Kokai) H08-271274 (citation 2))

In the citation 1, an obstacle is described on a two-dimensional plan lattice. By searching a valley line of potential place calculated based on a distance from the obstacle on circumference area of the obstacle, a path of a mobile object is calculated and generated.

In the citation 2, in general, a robot working in outdoor land not readjust moves by avoiding a large slope. From this viewpoint, by adding height data (above the sea) onto the two-dimensional plan lattice, a path is calculated based on the height data and created.

In the network map, each representative point is shown as a node, and a relationship among representative points is described by a link connecting these points. In detail, the network map is moving path data satisfied with a predetermined condition that a robot moves from some node (place) to another node.

By adding distance data to each link, a path satisfied with a condition such as a total extension and the minimum of the moving path can be calculated and created. Furthermore, by adding direction data of each link connected with nodes, a suitable path search method using a robot's movable network map (based on the created path) is proposed. (For example, Japanese Patent Disclosure (Kokai) H05-101035)

By using above two kinds of map data and setting a place adjacent to a user's position as a destination, a path from a robot's present position to the destination can be calculated and created. Room data as a moving path of the robot from some room to a user's room can be created using the network map. Furthermore, a moving path in each room and a moving path in a room where both the robot and the user exist can be created using the workspace map.

In this case, the robot must understand the space in which the user moves to predict the user's destination and observe the user. Such user movable space often changes with the passage of time. However, if the user movable space (understood by the robot) does not match with actual situation, the robot's observation ability falls.

### SUMMARY OF THE INVENTION

The present invention is directed to a mobile robot and a mobile robot control method for automatically improving the ability to observe a user while working.

According to an aspect of the present invention, there is provided a mobile robot comprising: a user position data acquisition unit configured to acquire user position data representing a user's position; a user movable space generation unit configured to generate user movable space data representing a space in which the user moves based on the user position data; and a position relationship control unit configured to control a position relationship between the user and the mobile robot based on the user movable space data.

According to another aspect of the present invention, there is also provided a method for controlling a mobile robot, comprising: acquiring user potion data representing a user's position; generating user movable space data representing a space in which the user moves based on the user position data; and controlling a position relationship between the user and the mobile robot based on the user movable space data.

According to still another aspect of the present invention, there is also provided a computer program product, comprising: a computer readable program code embodied in said product for causing a computer to control a mobile robot, said computer readable program code comprising: a first program code to acquire user position data representing a user's position; a second program code to generate user movable space data representing a space in which the user moves based on the user position data; and a third program code to control a position relationship between the user and the mobile robot based on the user movable space data.

### BRIEF DESCRIPTION OF THE DRAWINGS

FIG. 1 is a block diagram of a mobile robot according to a first embodiment.

FIG. 2 is one example of information stored in a map data memory in FIG. 1.

FIG. 3 is component of a user's movable rooms in movable room component data according to the first embodiment.

FIG. 4 is a plan view of a movable space map of a living room stored in the map data memory.

FIG. 5 is a plan view of a movable path of the living room stored in the map data memory

FIG. 6 is a block diagram of a detection unit in FIG. 1.

FIG. 7 is a schematic diagram of a user detection area according to the first embodiment.

FIG. 8 is a component of movable room component data with reference data of abnormality detection in FIG. 3.

FIG. 9 is a schematic diagram of creation method of the movable space map based on the user's position according to the first embodiment.

FIG. 10 is a flow chart of processing of a mobile robot control method according to the first embodiment.

FIG. 11 is a flow chart of processing of the detection unit and a user position decision unit in FIG. 1.

FIG. 12 is a schematic diagram of selection method of a user's predicted path in FIG. 7.

FIG. 13 is a flow chart of preprocessing of tracking according to the first embodiment.

FIG. 14 is a schematic diagram of relationship between a user disappearance direction and a user existence area in FIG. 7.

FIG. 15 is a schematic diagram of a user tracking method using the user existence area in FIG. 7.

FIG. 16 is a distribution of a user existence expected value at a short passed time from missing the user.

FIG. 17 is a distribution of the user existence expected value at a middle passed time from missing the user.

FIG. 18 is a distribution of the user existence expected value at a long passed time from missing the user.

FIG. 19 is a transition of the user existence expected value based on the passed time.

FIG. 20 is a distribution of the user existence expected value of each room based on a distance between rooms.

FIG. 21 is a graph of the user existence expected value corresponding to a moving distance guided from a distribution of a user moving distance.

FIG. 22 is a graph of a relationship between the passed time and the maximum moving distance in case of a user's moving speed below a threshold.

FIG. 23 is a graph of a user existence expected value guided from the maximum moving distance in case of a user's moving speed below a threshold.

FIG. 24 is a schematic diagram of the relationship among a user, a robot, and an obstacle in a movable space according to a second embodiment.

FIG. 25 is a block diagram of a moving robot according to the second embodiment.

FIG. 26 is one example of information of a map data memory in FIG. 25.

FIG. 27 is a plan view of a user's movable space map of a living room stored in the map data memory.

FIG. 28 is a plan view of a robot's movable space map of a living room stored in the map data memory.

FIG. 29 is a flow chart of prediction processing of a user's moving path according to the second embodiment.

FIG. 30 is a plan view of a robot's movable space map of a living room with a user's movable path.

FIG. 31 is a plan view of a robot's movable space map of a living room with avoidant path guided from an obstacle avoidance method.

FIG. 32 is a plan view of a robot's movable space map of a living room with a suitable avoidant path selected from the avoidant paths in FIG. 31.

### DETAILED DESCRIPTION OF THE EMBODIMENTS

Hereinafter, various embodiments of the present invention will be explained by referring to the drawings. The present invention is not limited to following embodiments.

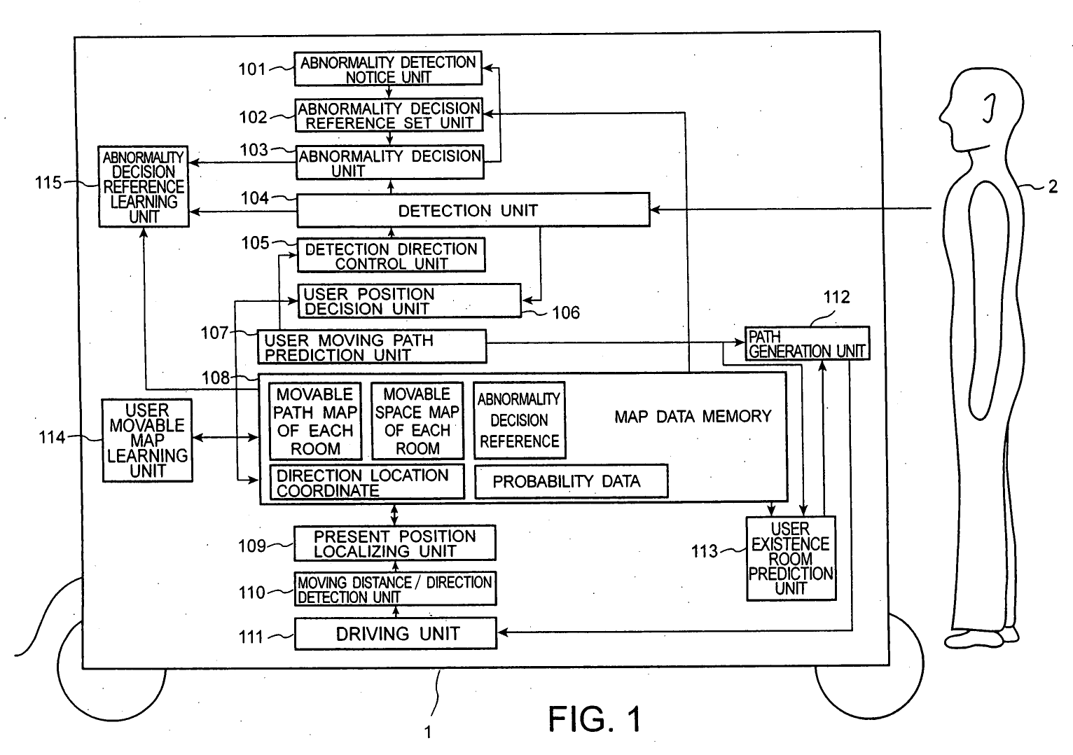

A first embodiment is explained by referring to FIGS. 1˜23. FIG. 1 is a block diagram of a mobile robot 1 according to the first embodiment. As shown in FIG. 1, the mobile robot 1 includes an abnormality decision notice unit 101, an abnormality decision reference set unit 102, an abnormality decision unit 103, a detection unit 104, a detection direction control unit 105, a user position decision unit 106, a user moving path prediction unit 107, a map data memory 108, a present position localizing unit 109, a moving distance/direction detection unit 110, a driving unit 111, a path generation unit 112, a user existence room prediction unit 113, a user movable map learning unit 114, and an abnormality decision reference learning unit 115. The mobile robot 1 searches and traces a user, and observes the user's abnormality (unusual status).

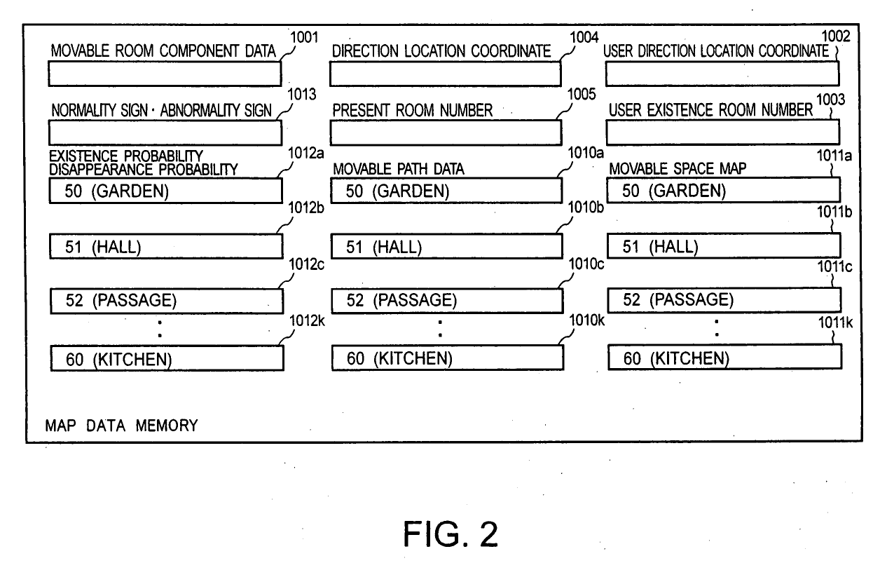

The map data memory 108 stores a component map of a room, a map of each room, a present position of the mobile robot 1 and a user 2. In this case, position means a location and a direction. FIG. 2 is information stored in the map data memory 108. The information includes movable room component data 1001, a movable space map 1011a˜k of each room, movable path data 1010a˜k of each room, a user direction location coordinate 1002, a user existence room number 1003, a direction location coordinate 1004, a present room number 1005, an existence probability/disappearance probability 1012a˜k of each room, and normality sign/abnormality sign 1013 of each room.

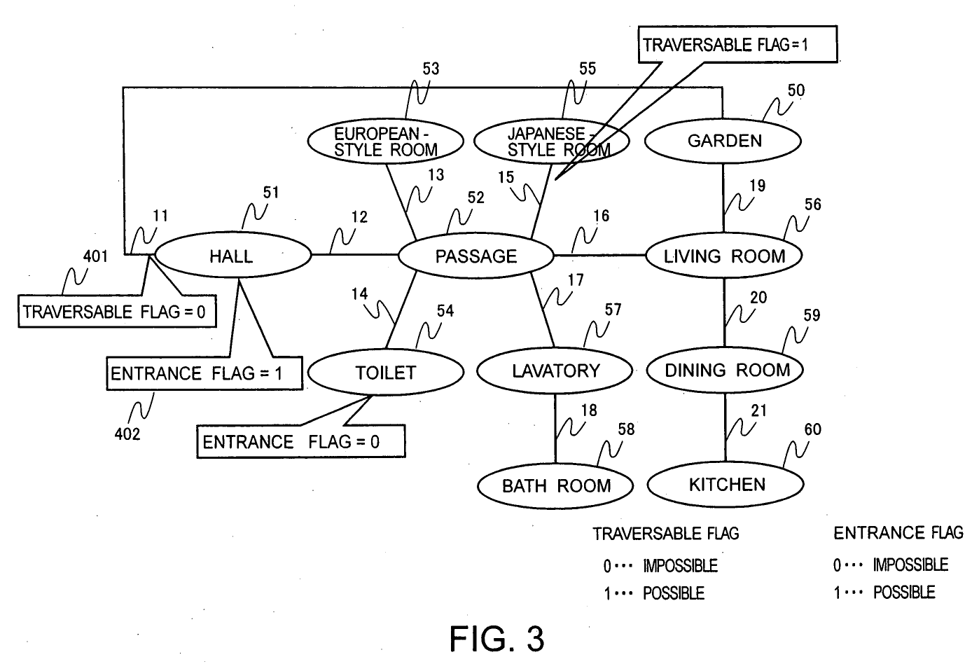

FIG. 3 is one example of the movable room component data 1001. The movable room component data 1001 represent movable rooms in a user's house. In FIG. 3, a garden 50, a hall 51, a passage 52, an European-style room 53, a toilet 54, a Japanese-style room 55, a living room 56, a lavatory 57, a bath room 58, a dining room 59, and a kitchen 60 compose each room as a place (node) in the house. Furthermore, a link line connecting two places represents a doorway 11˜21 of each room.

In the movable room component data 1001, all the user's movable space in the house is described as each place. In each place, an entrance flag 402 representing whether the robot 1 can enter is added to each place, and a traversable flag 401 representing whether the robot 1 can traverse is added to each link line. In order to detect and track the user, the movable space map 1011 including an entrance place and non-entrance place neighbored with the entrance place may be stored in the map data memory 108.

Actually, travel ability of the mobile robot 1 has a limit. In general, the mobile robot 1 cannot enter the garden 50, the toilet 54, or the bath room 58. In this case, the entrance flag 402 of these rooms is set to “0” and the entrance flag 402 of other rooms is set to “1”. Furthermore, it is impossible to traverse from the hall 51 to the garden 50. In this case, the traversable flag 401 of this link is set to “0” and the traversable flag 401 of other links is set to “1”. In case of use the traversable flag 401 with the entrance flag 402, it is considered that the robot 1 cannot enter a room from some doorway but can enter the room from another doorway. Accordingly, both the traversable flag 401 and the entrance flag 401 are not always necessary. Only one of these flags is often enough.

Even if the robot 1 cannot enter the room and traverse from the doorway, all places (rooms) and all links (doorways) are contained. Accordingly, this movable room component data 1001 are not only path data for the robot 1 to move but also path data for the user 2 to move in order for the robot 1 to search for the user 2.

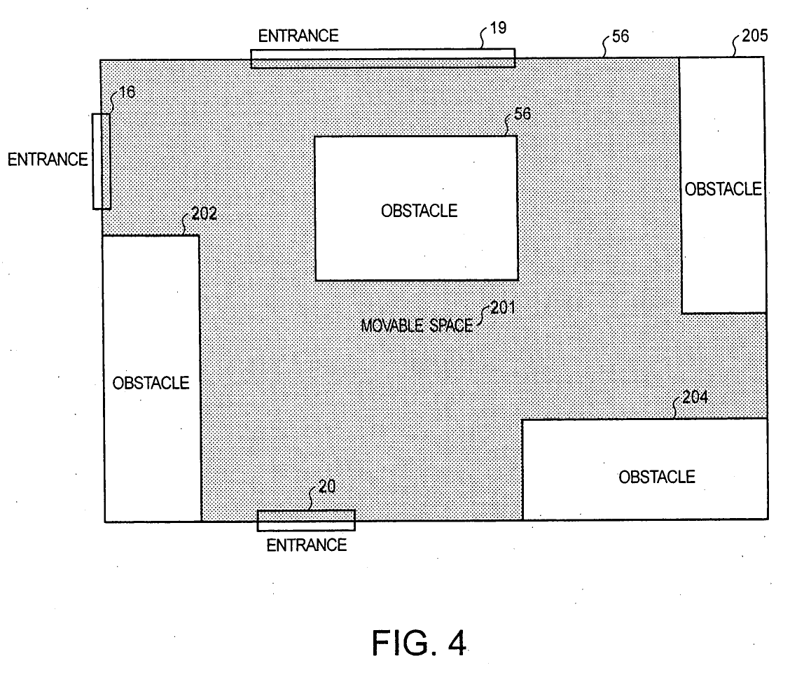

The movable space map 1011a˜k of each room represents user movable space data (map data) as a user's movable space of each room. FIG. 4 is a movable space map 1011g of the living 56. In FIG. 4, a space excluding obstacles 202, 203, 204, and 205 is a user's movable space 201. In addition to this, doorways 16, 19, and 20 to another room are included.

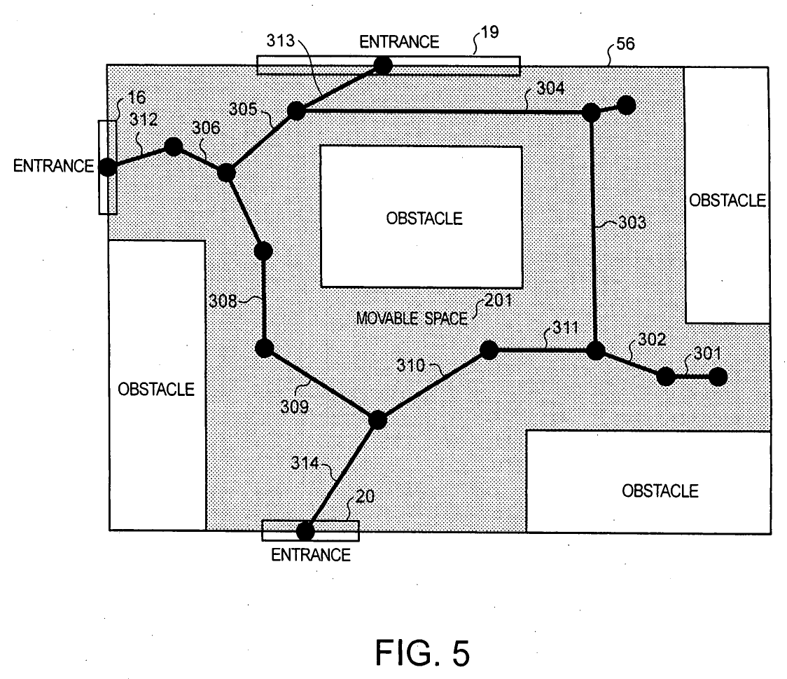

The movable path data 1010a˜k of each room represents a user's movable path on the movable space map 1011 of each room. FIG. 5 is the movable path data on the movable space map 1011g of the living room 56. This movable path data includes segments 301˜311 as a path passing through a center part of the movable space 201 on the movable space map 1011g, and additional segments 312˜314 connecting a center of each doorway 16, 19, and 20 with an edge point of the nearest segment. The segments 301˜311 of the movable path data 1010g are created by thinning processing (By gradually narrowing an area from outline, pixel lines remain at a center part of the area) and segmentation processing (continuous pixel lines are approximated by a straight line) on a plan image of the movable space 201 of the movable space map 1011g. Furthermore, by segmentation-processing a valley line (point lines) of potential field (disclosed in the citation 1), the same result is obtained. In the first embodiment, by adding the segments 312˜314 connecting each doorway with the nearest segment edge point, a path to each doorway is added to a moving path of a center part on the movable space 201.

The user direction location coordinate 1002 represents direction/location of a user's existence in the room. A location coordinate and a direction on the movable space map 1011 are stored in the map data memory 108. The user direction location coordinate 1002 is determined by a direction location coordinate 1004 of the robot 1 and a relative distance/direction between the robot 1 and the user 2 (detected by the detection unit 104 as explained afterwards). Based on these data, the user's location coordinate and direction on the movable space 1011 is calculated by the user position decision unit 106 (explained afterwards).

The user existence room number 1003 represents a room number where the user exists, and this room number is stored in the map data memory 108. An abnormality decision reference (explained afterwards) is set based on the user existence room number 1003. For example, in case of deciding that the robot 1 exists in the passage 52 and the user 2 moves to the toilet 54, the robot 1 cannot move to the toilet 54 because of the entrance flag “1” of the toilet 54. In this case, the robot 1 updates the user existence room number 1003 as “54”, and the abnormality decision reference set section 102 sets the abnormality decision reference based on the updated room number.

The direction location coordinate 1004 represents a direction/location of the robot 1 in the room, and a location coordinate and a direction on the movable space 1011 is stored in the map data memory 108. The direction location coordinate 1004 is localized by the present location localizing unit 109 using a moving distance/direction and a previous direction location coordinate 1004.

The present room number 1005 represents a number of a room where the robot 1 exists at the present, and the room number is stored in the map data memory 108. In case of deciding that the robot 1 passed through the doorways 11˜21 while moving, a value of the present room number 1005 is updated. After that, based on the movable space map 1011 and the movable path data 1010 corresponding to the updated room number 1005, the user's-location coordinate is localized, the user's moving path is predicted, and the robot's location coordinate is localized.

The existence probability/disappearance probability 1012a˜k represent existence probability data and disappearance probability data based on the user's position on the movable space map 1011 of each room. The existence probability data is a calculated from the time that the user stays at the same position, based on the user's hourly position obtained as the direction location coordinate 1004. This probability is calculated as a ratio of time that the user is staying at the same position to all time that the user is observed. Furthermore, the disappearance probability data is a probability calculated by a number of missing occurrence at the same position where the robot 1 missed the user 2. This probability is calculated as a ratio of a number of missing occurrence of the user at a position to a number of detection of the user at the position. Accordingly, the existence probability represents a possibility that the user exists at a position, and the disappearance probability represents a possibility that the robot misses the user at a position during the user's existing. The existence probability/disappearance probability is updated by the user movable map learning unit 114. The user movable map learning unit 114 functions as an additional means of existence probability data and disappearance probability data.

The normality sign/abnormality sign 1013 represents normality sign data and abnormality sign data of the user 2 at each place (node) on the movable room component data 1001. The normality sign data is feature data in an observation signal detected by a sensor of the robot 1 while the user 2 is active at the position. For example, a changing sound of a shower, the sound of a flush toilet, a rolling sound of toilet paper, and open and shut sound of a door are applied. The abnormality sign data is feature data in an observation signal detected by a sensor of the robot 2 while the user 2 is under an abnormal status at the position. For example, a fixed continuous sound of a shower, a crash sound of glass, a falling sound of an object, a cry, and a scream are applied. The normality sign data represents possibility that the user 2 is under the abnormal status when the normality sign data is not observed, and the abnormality sign data represents the user's abnormal status when the abnormality sign data is observed. Based on the user's position, the abnormality decision reference set unit 102 reads out the normality sign data/abnormality sign data, and sets the present abnormality reference. The normality sign data/abnormality sign data are initially provided as preset data (foreseen data). However, in response to a decision result of normality/abnormality from the abnormality decision unit 103, if feature data except for the normality sign data/abnormality sign data preset is detected from the observation signal, the abnormality decision reference learning unit 115 adds the feature data as new normality sign data/abnormality sign data during the robot's working.

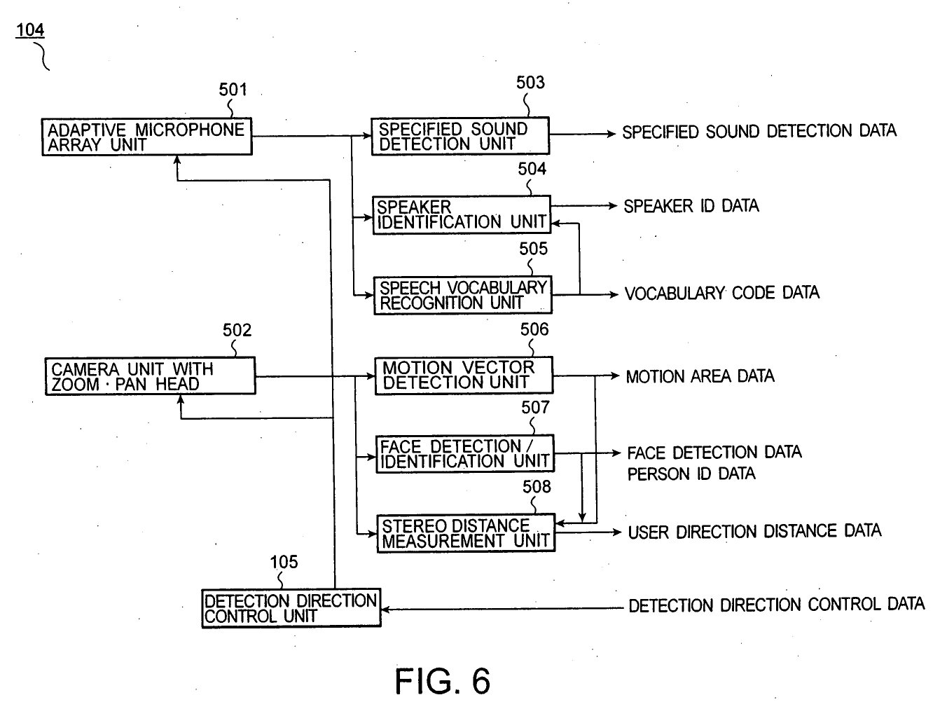

As shown in FIG. 6, the detection unit 104 includes an adaptive microphone array unit 501 and a camera unit 502 with a zoom/pan head. Detection direction of the adaptive microphone array unit 501 and the camera unit 502 is controlled by the detection direction control unit 105. Output from the adaptive microphone array unit 501 is supplied to a specified sound detection unit 503, a speaker identification unit 504 and a speech vocabulary recognition unit 505. Output from the camera unit 502 is supplied to a motion vector detection unit 506, a face detection/identification unit 507, and a stereo distance measurement unit 508.

The adaptive microphone array unit 501 (having a plurality of microphones) receives speech from a detection direction indicated by separating from a surrounding noise. The camera unit 502 with zoom/pan head is a stereo camera having an electric zoom and an electric pan head (movable for pan/tilt). A directivity direction of the adaptive microphone array 501 and the zoom and pan/tilt angle (parameter to determined directivity of camera) of the camera unit 502 are controlled by the detection direction control unit 105.

The specified sound detection unit 503 is an acoustic signal analysis device to detect a sound having a short time damping, a specified spectral pattern and the variation pattern from the input sound. The sound having the short time damping is, for example, a crash sound of glass, a falling sound of object, and a shut sound of door. The sound having the predetermined spectral pattern is, for example, a sound of shower, a sound of a flushing toilet, and a rolling sound of toilet paper.

The speaker identification unit 504 is a means to identify a person from the speech input by the adaptive microphone array unit 501. By matching Formant (strong frequency element in spectral pattern) peculiar to the person included in the spectral pattern of the input speech, a speaker ID of the person is outputted.

The speech vocabulary recognition unit 505 executes pattern-matching of the speech (input by the adaptive microphone array unit 501), and outputs vocabularies as the utterance content by converting to characters or vocabulary codes. The Formant for speaker identification is changed by the utterance content. Accordingly, the speaker identification unit 504 executes Formant-matching using a reference pattern based on vocabulary (recognized by the speech vocabulary recognition unit 505). By this matching method, irrespective of various utterance contents, the speaker can be identified and a speaker ID as the identification result is outputted.

The motion vector detection unit 506 calculates a vector (optical flow vector) representing a moving direction of each small area from the image (input by the camera unit 502), and divides the image into a plurality of areas each of which motion is different by grouping each flow vector having the same motion. Based on this information, a relative moving direction of the person from the robot 1 is calculated.

The face detection/identification unit 507 detects a face area from the image (input by the camera unit 502) by pattern-matching, identifies a person from the face area, and outputs an ID of the person.

The stereo distance measurement unit 508 calculates a parallax of both pupils of each part from a stereo image (input by the camera unit 502), measures a distance of each part based on the principle of triangulation, and calculates a relative distance from the robot 1 to each part based on the measurement result. Each part (distance measurement object) in the image is a moving area detected by the motion vector detection unit 506 or a face area detected by the face detection/identification unit 507. As a result, a distance to a face visually detected or three-dimensional motion vector of each moving area can be calculated.

Based on a decision result whether a person is the user 2 by the speaker ID or the person ID (input by the detection unit 104), a relative direction/distance (input by the detection unit 104), and a location coordinate/direction of the robot 1 (direction location coordinate 1004) stored in the map data memory 108, the user position decision unit 106 guides an existence location and a moving direction of the user 2, and calculates a location coordinate/direction of the user 2 on the movable space map 1011. The location coordinate/direction is stored as the user direction location coordinate 1002 in the map data memory 108. The user position decision unit 106 reads observable evidence representing the user's existence from input data by the detection unit 104.

The user moving path prediction unit 107 predicts a moving path and an existence area of the user 2 on the movable space map 1011 based on the user direction location coordinate 1002 (the user's location at the present or at the last detected time) and the movable path data 1010.

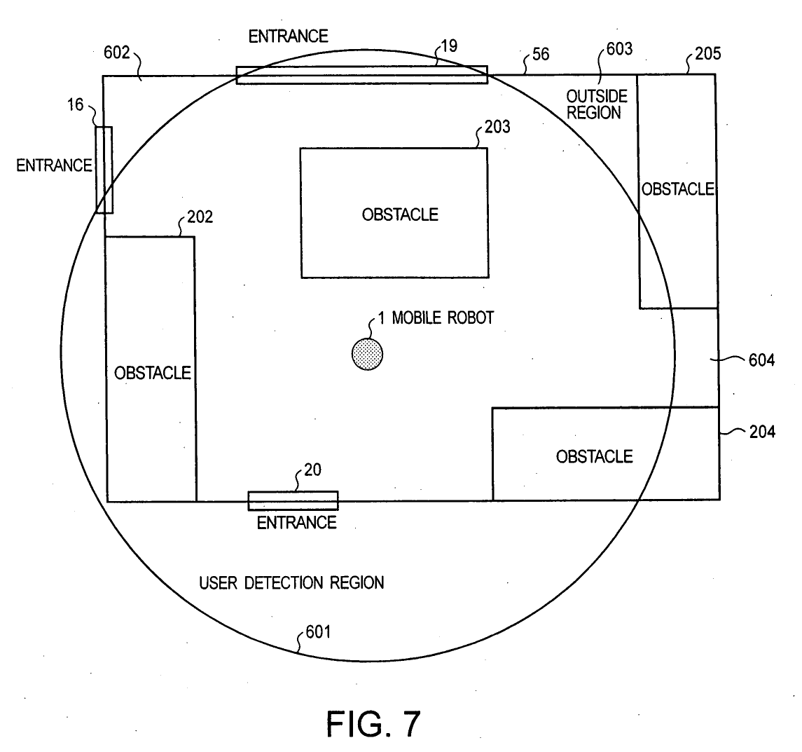

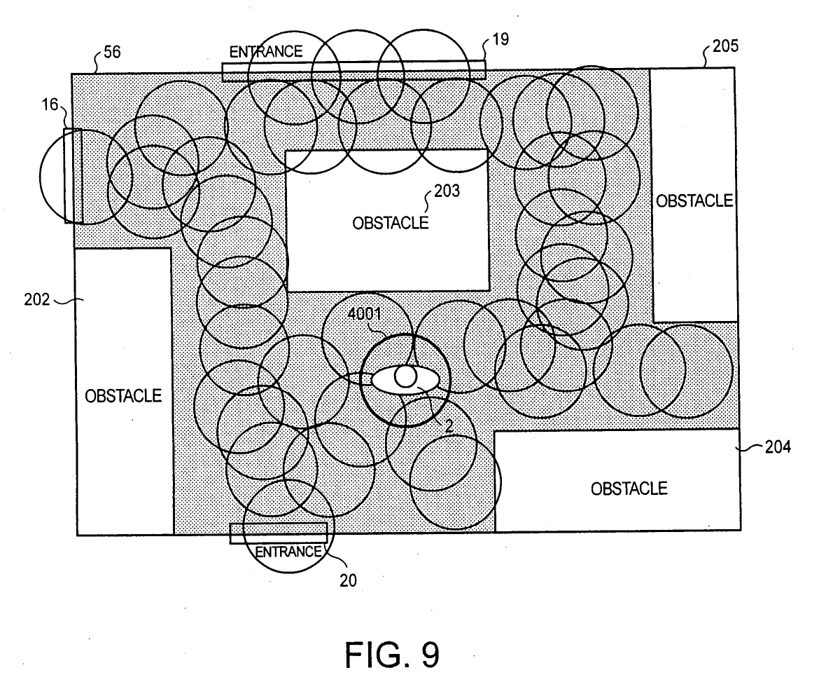

The detection direction control unit 105 is used for searches whether the user 2 exists in a user detection region 601 (FIG. 7) and tracks a detection direction (S5 in FIG. 9) in order not to miss the user 2. In the first embodiment, the detection direction control unit 105 controls a detection direction of the adaptive microphone array unit 501, and an electric zoom and pan/tilt angle of the camera unit 502.

As a matter of course, a sensor of the detection unit 104 has an effective space range. An expanse of the effective space range can change based on environment condition where the robot 1 works. In case that the detection direction control unit 105 controls the detection unit 104 along all directions, the effective space range is almost a circle region. FIG. 7 shows an effective space range as a user detection region 601. When the user 2 is in the user detection region 601, by controlling the detection unit 104 using the detection direction control unit 105, the robot 1 detects the user 2. In this case, spaces 602˜604 extending to outside of the user detection region 601 on the movable space map 1011 are non-detection regions. When the user 2 exists in the non-detection region, the robot 1 cannot detect the user 2.

In case of not detecting the user 2, based on prediction of the doorway used for the user's moving (by the user moving path prediction unit 107), the user existence room prediction unit 113 predicts a room where the user 2 may exist using the movable room component data 1001.

The path generation unit 112 creates trace path data based on the predicted path of the user 2 (by the user moving path prediction unit 107), the present position of the robot 1 and the movable path data 1010. Furthermore, the path generation unit 112 creates a search path from the robot's present position to the predicted room where the user 2 may exist (by the user existence room prediction unit 113), based on the movable room component data 1001, the movable path data 1010, and the movable space map 1011.

The driving unit 111 drives each unit based on the path data (generated by the path generation unit 112), and controls the robot 1 to move.

The moving distance/direction detection unit 110 obtains a moving distance/direction by the driving unit 111. In the first embodiment, the robot 1 has a gyro and a pulse encoder, and the moving distance/direction of the robot 1 is detected using them. The moving distance/direction is output to the present position localizing unit 109.

The present position localizing unit 109 localizes the present position of the robot 1 based on the moving distance/direction (output by the moving distance/direction detection unit 110) and the direction location coordinate 1004 before the robot moves (stored in the map data memory 108). The direction location coordinate 1004 (stored in the map data memory 108) is updated by a direction and a coordinate of present location of the robot 1 localized. Furthermore, in case of deciding that the robot 1 moves to another room (different from the room where the robot existed before moving), the present room number 1005 in the map data memory 108 is updated by a room number of another room.

The abnormality decision reference set unit 102 sets a reference to detect the user's abnormal status based on the room where the user 2 exists. The abnormality decision reference set unit 102 sets the abnormality decision method not by a room where the robot 1 exists but by a room where the user 2 exists.

As an example of the reference, when the user 2 is in the toilet 54, in case of the user's normal status, a rolling sound of toilet paper and a flushing sound of water must be heard through a door of the toilet. This is called “normality sign data” of the user 2, which represents the user's action without abnormality. The robot 1 cannot move to the toilet 54 because the entrance flag 402 of the toilet 54 is “0”. Accordingly, the robot 1 observes the normality sign data from the passage 52 neighbored with the toilet 54. As a matter of course, even if the robot 1 exists on the passage 52, when the user 2 exists in another room into which the robot 1 cannot enter, the robot 1 observes another normality sign data.

For example, when the user 2 is in the bath room 58, in case of the user's normal status, a shower sound is intermittently heard through a door of the bath room. The robot 1 cannot enter the bath room 58 in the same way as the toilet 54. Accordingly, the robot 1 observes an intermittent sound of shower (strength change of flush sound occurred while operating the shower) and a water sound of bathtub as the normality sign data from the lavatory 57 into which the robot 1 can enter. If the shower sound is intermittently heard, it is an evidence which the user 2 is operating the shower. If the shower sound is continuously heard, it is evidence that the user 2 have fallen by leaving the shower flowing. Accordingly, continuous shower sound is reversely “abnormality sign data”.

As another abnormality sign data, a predetermined sound such as a scream and a groan is included. Furthermore, as another normality sign data, the user's voice is included. The normality sign data and the abnormality sign data are detected by the detection unit 104.

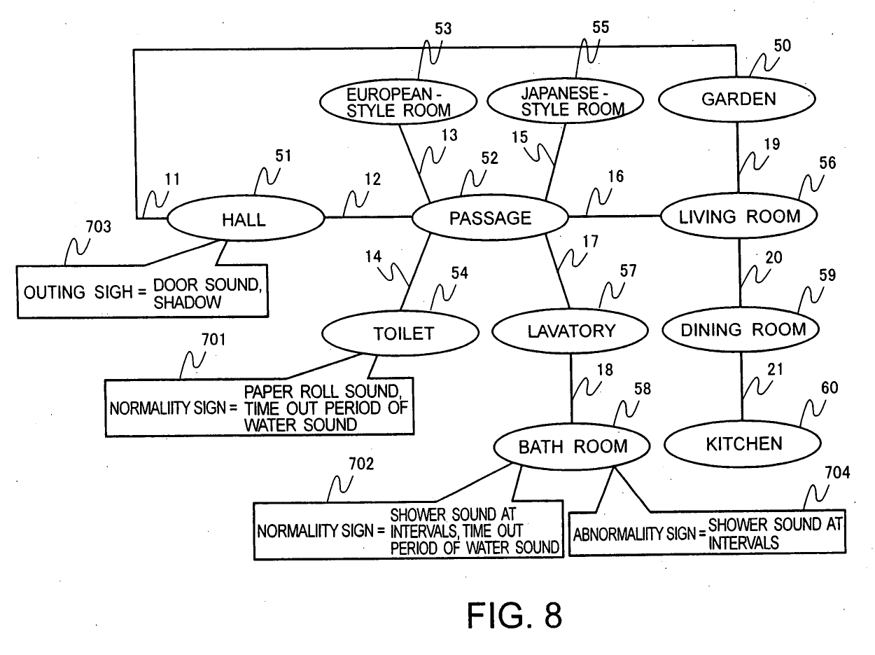

In the first embodiment, as the reference to decide abnormality, the normality sign data and the abnormality sign data come from the user's existence room are used. The abnormality detection reference data (such as the normality sign data and the abnormality sign data) are linked to each room of the movable room component data 1001 as a reference. FIG. 8 schematically shows movable room component data linked with the abnormality detection reference data. Furthermore, the movable room component data includes an outing sign related with a room from which the user 2 can go out. The outing sign is a sign to decide whether the user 2 went out from the house. Briefly, the outing sign is evidence representing that the user 2 went out from a doorway led to the outdoors. Actually, a situation that the user 2 is missed at the opposite side of doorway led to outdoor, or that the user 2 cannot be detected adjacent to the hall 51 over a predetermined period after observing open and shut sound of a door of the hall 51 are applied.

Then, in case of updating the user existence room number 1003, the abnormality decision reference set unit 102 sets the abnormality decision reference.

The abnormality decision unit 103 compares the normality sign data or the abnormality sign data (detected by the detection unit 104) with the abnormality decision reference (set by the abnormality decision reference set unit 102), and decides whether the user is under the abnormal status. In case of the abnormal status, this status signal is output to the abnormality detection notice unit 101.

In case that the normality sign data is not observed after the user's entering into the room, in case that normality sign data is not observed for a predetermined time from detection time of previous normality sign data, in case that the user 2 does not move from detection time of last normality sign data, or in case that abnormality sign data is observed, the abnormality decision unit 103 decides that the user 2 is under the abnormal status.

Furthermore, the abnormality decision unit 103 decides whether the user 2 goes out based on the outing sign. In case of detecting the outing sign by the detection unit 104, the robot 1 waits until the user 2 enters from the hall 51. Alternatively, after moving to the living room 56, the robot 1 waits until the user 2 enters from the garden 50. In case of deciding that the user 2 does not enter from the garden 50, the robot 1 waits at the hall 51 again. In these cases, by deciding that the user 2 goes out, abnormality detection using the normality sign data and the abnormality sign data is not executed. Next, in case of detecting the user's entrance from the hall or detecting the normality sign data such as door-open sound of the doorway 19 of the living room 56, the robot 1 begins to work.

The abnormality detection notice unit 101 notifies the observation center in case of receiving the user's abnormal status from the abnormality decision unit 103. In the first embodiment, notification is executed using a public circuit by a mobile phone. Furthermore, by giving a warning, caution may be urged to those around the user 2.

The user movable map learning unit 114 creates user movable space data as a movable space map 1011 of each place (room) based on a position coordinate of the user 2. FIG. 9 is a schematic diagram to explain a movable space map creation method. The entire area of the movable space map 1011 of each room is initially covered by obstacles. When the mobile robot 1 detects the position of the user 2, an occupation space 4001 is set at the position of the user 2 on the movable space map. The occupation space 4001 represents a space occupied by the user's body. In the first embodiment, the occupation space is set as a circle having a one meter diameter centered around the position of the user 2. The user 2 moves in the room while avoiding obstacles. The occupation space 4001 is moved by the user's moving. As a result, by overlapping the occupation space at each position, the user's movable space is determined. In this case, the occupation space 4001 often extends over an obstacle or through a wall on the movable space map. However, by thinning and segmentation processing, the movable path map 1010 created from the movable space map 1011 does not have much error.

The abnormality decision reference learning unit 115 generates normality sign data and abnormality sign data of each place (room) based on a location coordinate of the user 2 (by the user position decision unit 106). For example, the abnormality sign data, such as a cry and a groan, and the normality sign data, such as the user's speech except for the cry and the groan, are initially stored in the map data memory 108. These normality sign data and abnormality sign data are previously registered as effective sign of all places (rooms). Briefly, such general knowledge is preset in the robot 1 at start timing of operation.

Assume that, after entering the bathroom, the user 2 hums a tune while taking a bathtub. The abnormality decision unit 103 decides the user's normality based on the humming as evidence, which is the user's voice detected by the speaker identification unit 504 and of which vocabulary code by the speech vocabulary recognition unit 505 is not abnormality sign. In case of pausing the humming, when the known normality sign is detected, the abnormality decision unit 103 does not reverse decision of normality. Reversely, if the known normality sign is not detected over a predetermined period, the abnormality decision unit 103 decides the user's abnormality.

On the other hand, the abnormality decision reference learning unit 115 starts recording of an observation signal (obtained by the detection unit 104) from pause timing of the humming. In this case, if the user 2 occurs intermittent water sound (such as by pouring a hot water over his shoulder from the bathtub), this intermittent water sound is included in the observation signal. When the normality sign data is detected (such as the humming is recorded again) within a predetermined period, the abnormality decision reference learning unit 115 stops recording of the observation signal, extracts the intermittent water sound (acoustic signal of specified frequency range having a wave power along a time direction analyzed by the specified sound detection unit 503) from the recorded signal, and learns the intermittent water sound as new normality sign. This normality sign data is stored in correspondence with the bathroom. Hereafter, even if the user 2 does not hum a tune, as far as the water sound (already learned) is continually observed, the normality decision unit 103 decides that the user 2 is under the normal status. In the same way, a sound that a wash tub is put by the user is learned. As a result, various sounds of wide range are learned. Especially, as for the bathroom, sound detected from the bathroom only is individually learned. Accordingly, in comparison with the case that normality is decided by sound change only, the user's normality/abnormality can be correctly decided.

Furthermore, if the known normality sign data is not detected over a predetermined period after previous normality sign data is detected, the abnormality decision reference learning unit 115 stops recording the observation signal, and learns feature extracted from the recorded signal as new abnormality data. For example, assume that, immediately after pausing the humming, a hit sound with something is recorded (acoustic signal of short time damping having strong low frequency range analyzed by the specified sound detection unit 503). In this case, if the normality sign data is not detected after that, the hit sound is learned as the abnormality sign data. Furthermore, as operation of the abnormality detection notice unit 101, the robot 1 calls out to the user 2 or notifies the family.

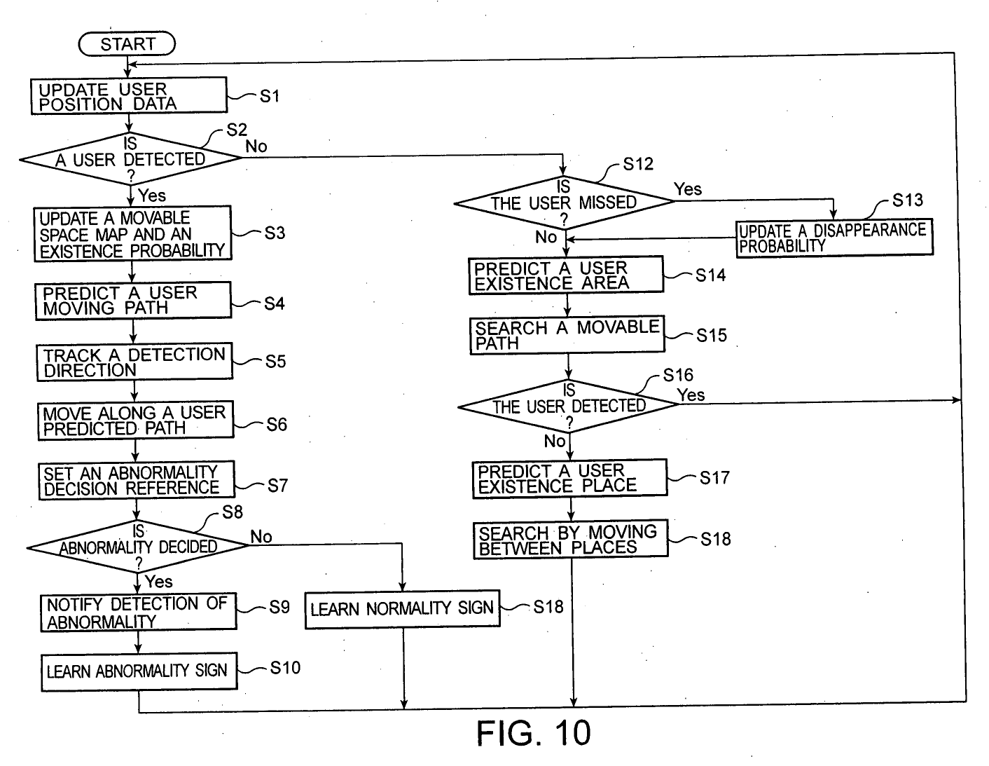

Next, processing component of the mobile robot 1 of the first embodiment is explained. FIG. 10 is a flow chart of all processing of the mobile robot 1 according to the first embodiment.

The user position decision unit 106 reads an observable evidence of the user's existence from input data (by the detection unit 104), and calculates a location coordinate of the user's existence on the movable space map 1011 based on a direction coordinate 1004 of the mobile robot 1 and a relative distance/direction of the user 2 from the robot 1 (S1). The observable evidence is called “user reaction”.

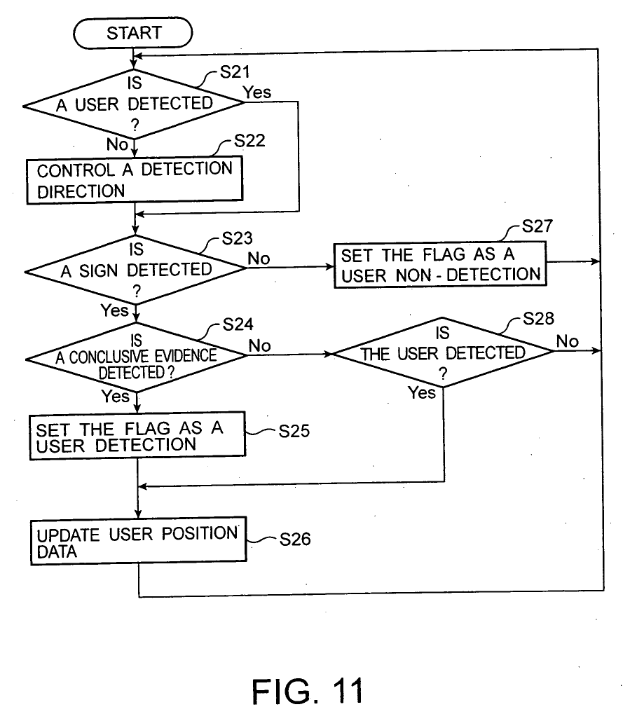

FIG. 11 is a flow chart of user position data update processing of S1 in FIG. 10. The user position data update processing includes a user detection decision step (S21), a detection direction control step (S22), a sign detection decision step (S23), a conclusive evidence detection decision step (S24), a user detection set step (S25), a user position data update step (S26), a user non-detection set step (s27), and a user detection decision step (S28).

At the user detection decision step (S21), the user position decision unit 106 checks a user detection flag representing whether the user is already detected. If the user detection flag is set as “non-detection” (No at S21), processing is forwarded to S22. If the user detection flag is set as “user detection” (Yes at S21), processing is forwarded to S23.

The detection direction control step (S22) is processing in case of non-detection of the user. The detection direction control unit 105 controls the detection unit 104 until all area of the user detection region 601 is searched or the user 2 is detected.

In case of “user detection” (S21) or after processing of S22, at the sign detection decision step (S23), the detection unit 104 verifies whether there is a sign representing the user's existence irrespective of whether the user is not detected. The sign is output of vocabulary code by the speech vocabulary recognition unit 505, output of motion area by the motion vector detection unit 506, and output of face detection data by the face detection/identification unit 507. In this step, in case of detecting the sign (Yes at S23), processing is forwarded to S24. In case of not detecting the sign (No at S23), processing is forwarded to S27. At the user non-detection set step (S27), the user position decision unit 106 decides that the sign is lost, and the user detection flag as “non-detection”.

At the conclusive evidence decision step (S24), the user position decision unit 106 verifies a conclusive evidence as a regular user. Conclusive evidence includes an output of speaker ID representing the user 2 by the speaker identification unit 504 or an output of person ID representing the user 2 by the face detection/identification unit 507. In this step, in case of detecting the conclusive evidence (Yes at S24), processing is forwarded to S25. In case of not detecting the conclusive evidence (No at S24), processing is forwarded to S28. In later case, the conclusive evidence is lost while the sign of the user 2 is detected.

In case of not detecting the conclusive evidence (No at S24), at the user detection decision step (S28), the user position decision unit 106 decides whether the user is detected by the user detection flag. In case of the flag “user detection”, the regular user is decided to be detected by the sign only.

In case of detecting the conclusive evidence (Yes at S24), at the user detection step (S25), the user position decision unit 106 decides that the conclusive evidence of the regular user is detected, and sets the user detection flag as “user detection”.

After step S25 or in case of deciding that the user is detected (Yes at S28), at the user existence data update step (S26), in case of detecting the sign or the conclusive evidence of the user 2, the user position decision unit 106 calculates a relative direction/distance of the center of gravity of a motion area (regular user). Based on the direction/location coordinate of the robot 1 (the direction location coordinate 1004), the user position decision unit 106 calculates an absolute position on the movable space map 1011 stored in the map data memory 108, and sets the absolute position as user position data. The user position data is stored as the user direction location coordinate 1002 in the map data memory 108. Briefly, status that the user position data is continually updated is a user reaction status.

In FIG. 10, after the user position data update step (S1), it is decided whether the user 2 is detected at S1 (S2). In case of detecting the user 2 (Yes at S2), the user movable map learning unit 114 calculates the occupation space 4001 based on the user's location coordinate stored in the user direction location coordinate 1002 (updated at S1), updates the movable space data 1011 by setting inside of the occupation space 4001 as a movable space, and updates the existence probability data 1012g corresponding to the user's location (S3). In the same way, the user moving path prediction unit 107 predicts a moving path based on the user's direction/location coordinate as the user direction location coordinate 1002 (updated at S1) and the movable path data 1010 (S4).

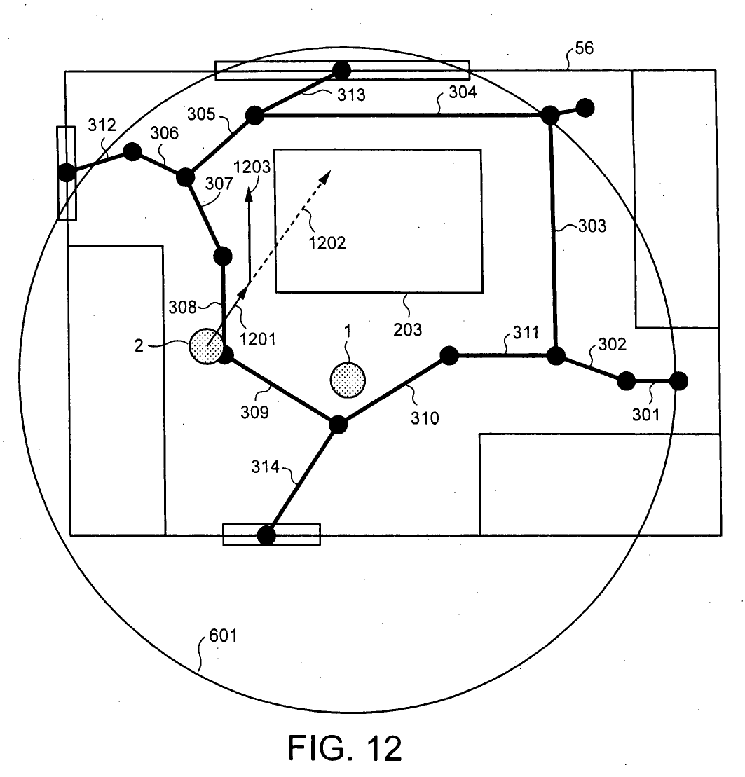

FIG. 12 is a schematic diagram to explain the user's path prediction method by the mobile robot 1. In FIG. 12, the mobile robot 1 and the user 2 respectively exist. Especially, the user 2 exists in a user detection region 601. Assume that the detection unit 104 in the robot 1 observes that the user 2 is moving along a direction of arrow 1201. If the user 2 is continually moving as it is, the user 2 will move along the direction of arrow 1201. However, actually, because of an obstacle 203, it is predicted that the user 2 turns to a direction of arrow 1203 along segment 308 on the movable path data 1010g. This inference is executed by the mobile robot 1. Concretely, the user moving path prediction unit 107 selects an edge point of segment 308 nearest the user's direction of arrow 1201 on the movable path data 1010g, and extracts all segments 307 and 309 connected with the edge point of the segment 308. Next, the edge point of the segment 308 is set as a start point of a vector, and other edge point of each segment 307 and 309 is respectively set as an end point of the vector. Next, a cosine between user's direction (vector) of arrow 1201 and each vector (segment 307, 309) is calculated as follows.
Cos θ=(v1·v2)/(|v1| |v2|)

v1: vector of arrow 1201, v2: vector of each segment 307,309

One segment having larger cosine value (direction is similar to the arrow 1201) is selected. In this example, the segment 308 is selected. The mobile robot 1 decides that the user's predicted path is a direction from the segment 308 to the segment 307.

In FIG. 10, after the user moving path prediction step (S4), the detection direction control unit 105 controls a detection direction of the detection unit 104 (the adaptive microphone array unit 501 and the camera unit 502), and the robot 1 tracks detection direction to continually observe the user 2 along the user predicted path (S5). Based on the user's location coordinate (the user direction location coordinate 1002) and the user predicted path (at S4), a tracking path to track along the predicted path is created. By tracing the tracking path, the robot 1 moves to run after the user (S6).

In this case, when the robot 1 detects that the user 2 enters into a place of which disappearance probability is above a threshold, the robot 1 tracks by raising moving speed in order not to miss the user 2.

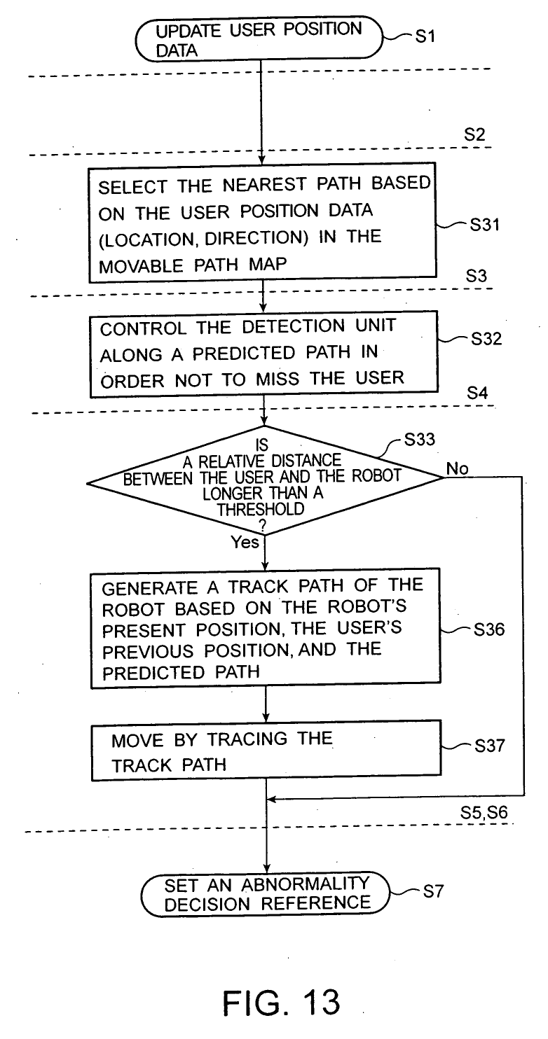

FIG. 13 is a detail flow chart of processing of steps S4˜S6 in FIG. 10. Based on the user's location/direction from the user position data (obtained at S1), a path nearest to the movable path data 1010g is a predicted path of the user 2 (S31). In order not to miss the user, the detection direction control unit 105 controls the detection unit 104 along the predicted path (S32). The detection unit 104 continuously detects the user in order not to miss the user. It is decided whether a relative distance between the robot 1 and the user 2 is longer than a threshold based on coordinate data of the robot 1 and the user on the movable space map 1011g (S33). In case of deciding that the relative distance is too distant, based on a path from the robot's present position to the user's existence position and the user's predicted path, the robot 1 generates a track path to track the user 2 (S36). By tracing the track path, the robot 1 tracks the user 2 (S37). In case of deciding that the relative distance is not too distant, the robot 1 does not move and processing is forwarded to the abnormality decision reference set (S7).

In FIG. 10, as a result of detection direction tracking and user predicted path moving, in case of detecting the user's location, the abnormality decision reference set unit 102 sets an abnormality decision reference based which room the user is in (S7), and abnormality detection by an observation method based on the abnormality decision reference is executed. If normality sign data is not observed after the user's entering into the room, if normality sign data is not observed over a predetermined period from detection time of previous normality sign data, if the user does not move from last detection time of normality sign data, or if abnormality sign data is detected, the robot 1 decides that the user 2 is under an abnormality status (Yes at S8), and the abnormality detection notice unit 101 notifies the observation center (S9). At the same time, the abnormality decision reference learning unit 115 learns another feature pattern of speech/image observed in the decision period, and the feature pattern is stored as new abnormality sign data (S10). On the other hand, if the user is under a normal status and normality sign data is obtained, the normality decision reference learning unit 115 learns another feature pattern of speech/image observed in the decision period, and the feature data is stored as new normality sign data (S11)

When the user 2 is not detected at S1 (No at S2) and if the user 2 detected just before is missed (Yes at S12), the user movable map learning unit 114 updates disappearance probability data 1012g corresponding to the user's location coordinate stored in the user direction location coordinate 1002 (S13). Based on the user's location coordinate/moving direction (user's disappearance direction) stored in the user direction location coordinate 1002, the user movable path prediction unit 107 and the user existence room prediction unit 113 predict the user's existence place (S14). This place is called “user existable region”. This includes “geometrical user existable region” predicted by the user moving path prediction unit 107 on the movable space map 1011 and “topological user existable region” predicted by the user existence room prediction unit 113 on the movable room component data 1001.

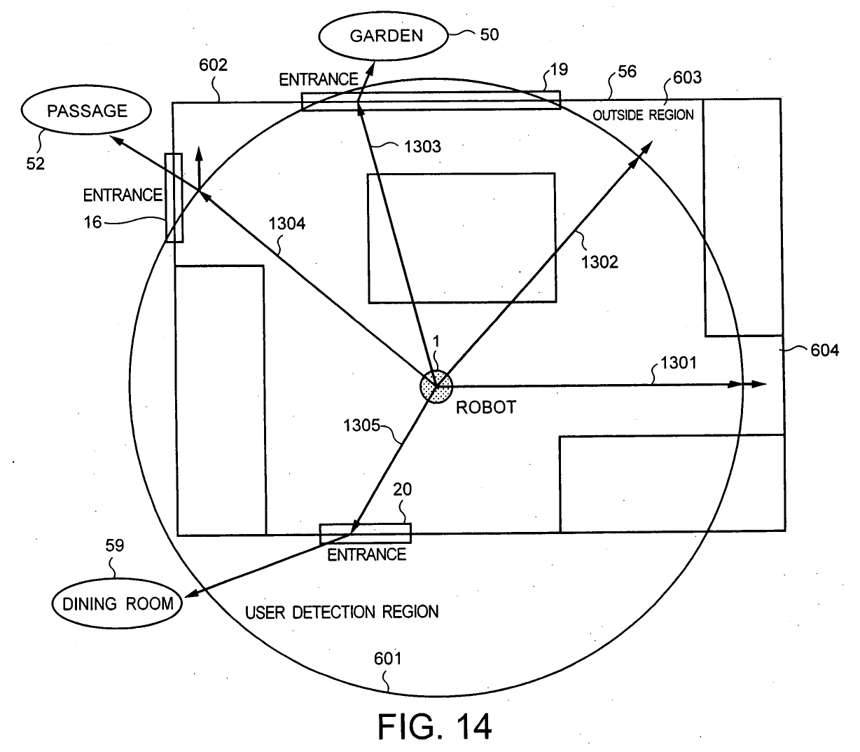

FIG. 14 is a schematic diagram to explain the prediction method of user's existence place. In FIG. 14, the geometrical user existable region is outside spaces 602˜604 of the user detection area 601 on the movable space map 1011. Furthermore, the topological user existable region is a garden 50, a passage 52, and a dining room 59 (of the movable room component data 1001) linked to a doorway 16 (in the geometrical user existable region), and doorways 19 and 20 (as the user's disappearance place in the user detection region).

If the user is last detected along directions 1301 or 1302 (user disappearance direction), the user existable region is outside region 604 or 603 on the movable space map. These places do not include doorways, and the user movable path prediction unit 107 decides that the user 2 probably exists in outside regions 604 or 603. In this case, degree that the user 2 respectively may exist in the outside regions 604 and 603 is calculated by the user existence probability data. For example, assume that the total of the user's existence probability in the outside regions 604 and 603 is respectively S(604) and S(603). By comparing both probabilities, the robot 1 can preferentially search for the user in the outside region having higher existence probability.

Furthermore, if the user is last detected along directions 1303 or 1305 (user disappearance direction), the user existable region is the garden 50 or the dining room 59 (of the movable room component data 1001) via doorways 19 and 20. The user movable path prediction unit 107 decides that the user 2 probably exists in the garden 50 or the dining room 59. In this case, degree that the user 2 respectively may exist in the garden 50 and the dining room 59 is calculated by the user existence probability data. For example, assume that the total of the user's existence probability in the garden 50 and the dining room 59 is respectively S(50) and S(59). By comparing both probabilities, the robot 1 can preferentially search for the user in the place having higher existence probability.

On the other hand, if the user is last detected along a direction 1304 (user disappearance direction), the user movable path prediction unit 107 predicts that the user is in either the outside region 602 in the user existable region or the passage 52 via the doorway 16. In this case, by calculating existence probability S(602) of the outside region 602 and S(52) of the passage 52, priority order is assigned.

In this way, the geometrical user existable region represents a place of high possibility that the user exists on the movable space map 1011, and the topological user existable region represents a place of high possibility that the user moved after missing. If the user 2 does not exist in the user detection region 601, the robot 1 searches for the user by referring to these data.

In the process of FIG. 10, the robot 1 moves in the user detection region 601 including the geometrical user existable region, and decides whether the user exists (S15).

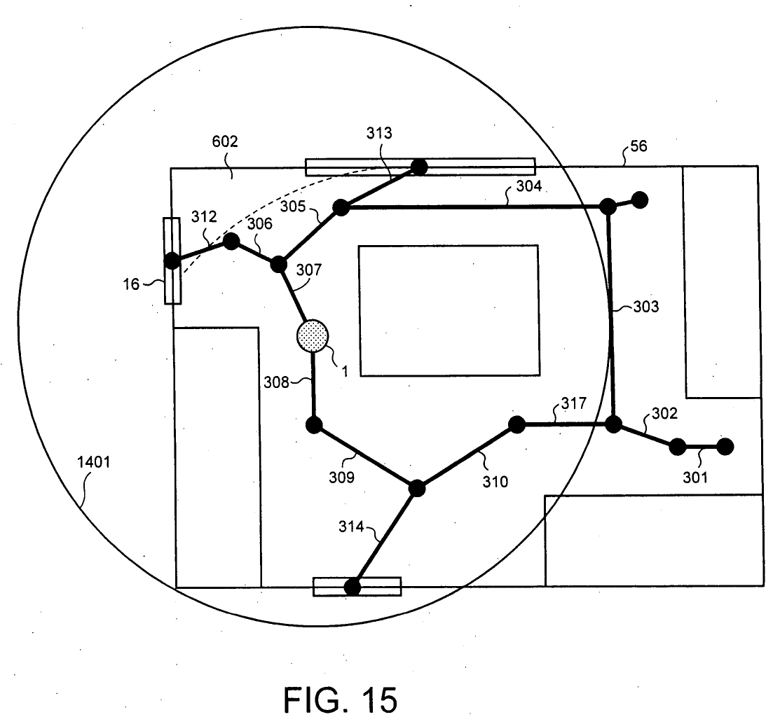

FIG. 15 shows the robot's locus as the robot 1 moves around the user existable region 601, including the geometrical user existable region 602 in FIG. 14. Assume the robot 1 is initially at the position shown and the user's disappearance direction last detected directs to the doorway 16 in FIG. 14. As shown in FIG. 15, the robot 1 advances to the doorway 16 along a path tracing segments 309, 308, and 307 on the movable path data 1010g, and decides whether the user 2 exists in the user existable region 1401 including the geometrical user existable region 602 of FIG. 14.

In the process of FIG. 10, in case of detecting the user 2 in the geometrical user existable region 602 (Yes at S16), the robot 1 restarts user-tracking (S1). In case of not detecting the user 2 in the geometrical user existable region 602 (No at S16), the user 2 ought to move to the passage 52 (or the other space) via the doorway 16. In this case, based on passed time from the robot's missing the user 2, the user existence room prediction unit 113 calculates an expected value that the user exists (“user existence expected value”) in each room linked to the passage 52 (S17).

The user existence expected value is, after the user 2 is out from a room (start room), for each room where the user can move from the start room in the movable room component data 1001, a degree of possibility that the user exists.

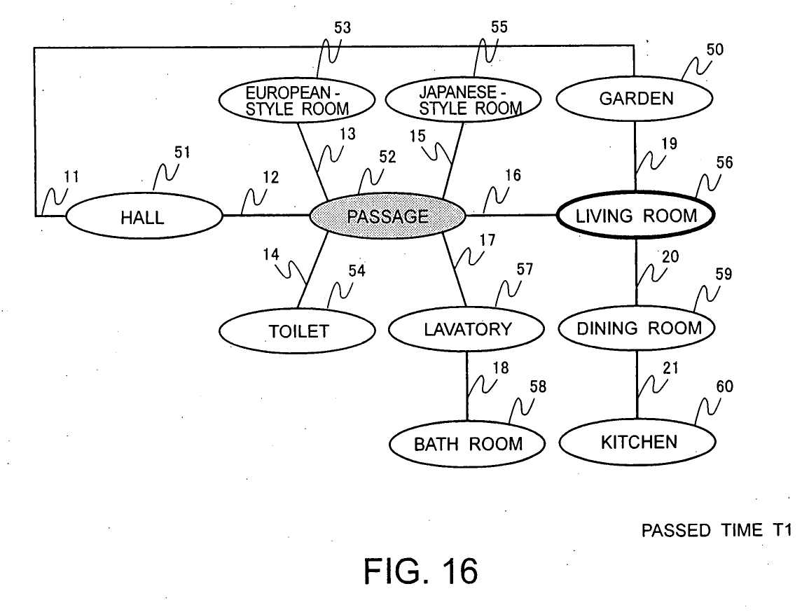

Based on passed time from the time when the robot 1 missed the user 2 and the room component data, FIGS. 16, 17, and 18 are schematic diagrams of the user existence expected value of each room. In FIGS. 16, 17, and 18, the darker a color of the room is, the higher the user existence expected value of the room is.

FIG. 16 is distribution of the user existence expected value in case of a short passed time (T1). As shown in FIG. 16, in case that the passed time is short, possibility that the user 2 moved to a distant room is low, and the possibility that the user is in the passage 52 is high.

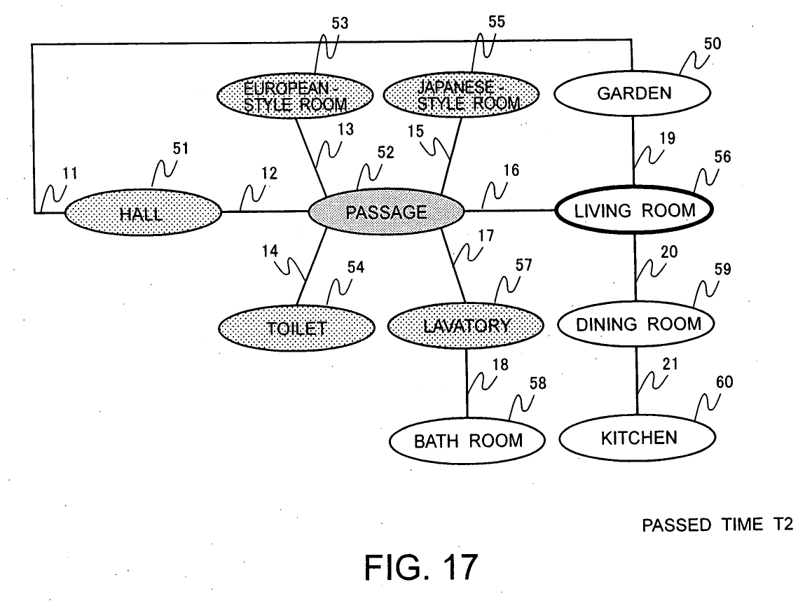

FIG. 17 is distribution of the user existence expected value in case of a middle passed time (T2). As shown in FIG. 17, in case that the time passed is greater than T1, possibility that the user 2 exists in the garden 51, the European-style room 53, the toilet 54, the Japanese-style room 55, or the lavatory 57 each neighbored with the passage 52 occurs.

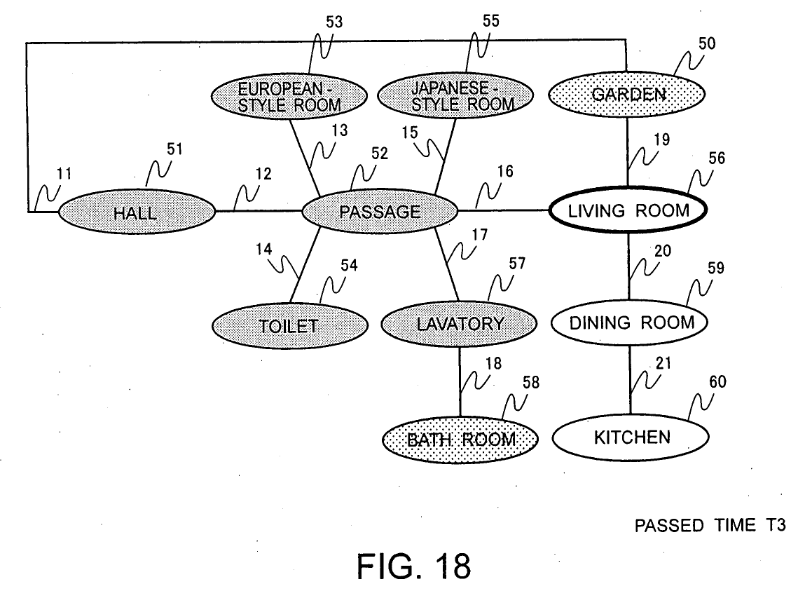

FIG. 18 is distribution of the user existence expected value in case of a long passed time (T3). As shown in FIG. 18, in case that the time passed is greater than T2, possibility that the user 2 moved to the garden 50 via the hall 51, or the bath room 58 via the lavatory 57 occurs.

The user existence expected value of each room is equally calculated based on room component without considering geometrical shape of each room. However, in case of moving from a room to another room, a moving path guided to each room is different based on geometrical shape of the room, and a moving distance in each room is different. Furthermore, a moving speed of the user 2 has a limitation. Accordingly, even if the user can move from the same room to a plurality of rooms, the user existence expected value of each room is different based on the moving distance in each room. Accordingly, the user existence room prediction unit 113 may calculate the user existence expected value based on the geometrical shape of each room as follows.

First, the user existence room prediction unit 113 calculates a distance from an exit of the start room to an entrance of another room accessible from the exit by summing the user's moving distance in each room passing from the exit to the entrance. For example, when the user 2 moves from the living room 56 to the bath room 58, it is determined that the user 2 moves to the bath room 58 via the passage 52 and the lavatory 57 based on the movable room component data 1001. In this case, the user's moving distance in the lavatory 57 is a moving distance from a doorway 17 (between the passage 52 and the lavatory 57) to a doorway 18 (between the lavatory 57 and the bath room 58). This is calculated as a length of minimum path between the doorways 17 and 18 in the movable path data 1010 of the lavatory 57.

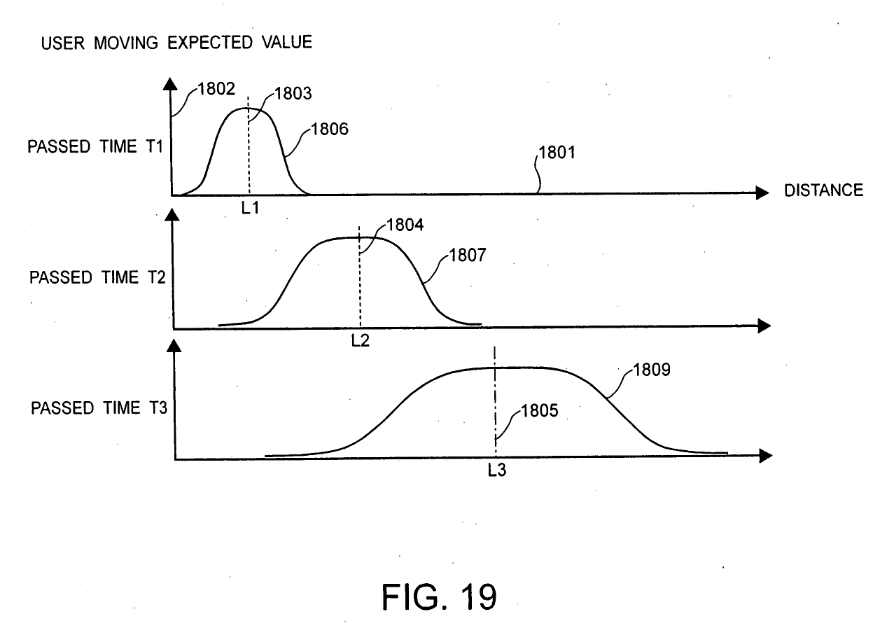

If the user 2 moves at a fixed moving speed, the user's moving distance is in proportion to the passed time. With passage of time, the user's reachable rooms include more distant rooms. Actually, the user's moving speed changes with the passage of time, and the user's moving distance in a predetermined period represents a distribution of some expected value. FIG. 19 is a graph of the distribution of expected values. In FIG. 19, the horizontal axis represents distance traveled, and the vertical axis represents the probability that the user 2 reaches some distance. As the passed time increases as T1, T2, and T3, the distance as the maximum of the expected value moves more distant as L1, L2, and L3. Furthermore, the distribution of the expected value of the user's moving distance represents curved lines 1806, 1807, and 1809 as smoother shape because of change of the moving speed. In FIG. 19, a distribution shape of the user moving distance probability is modeled by the normal distribution.

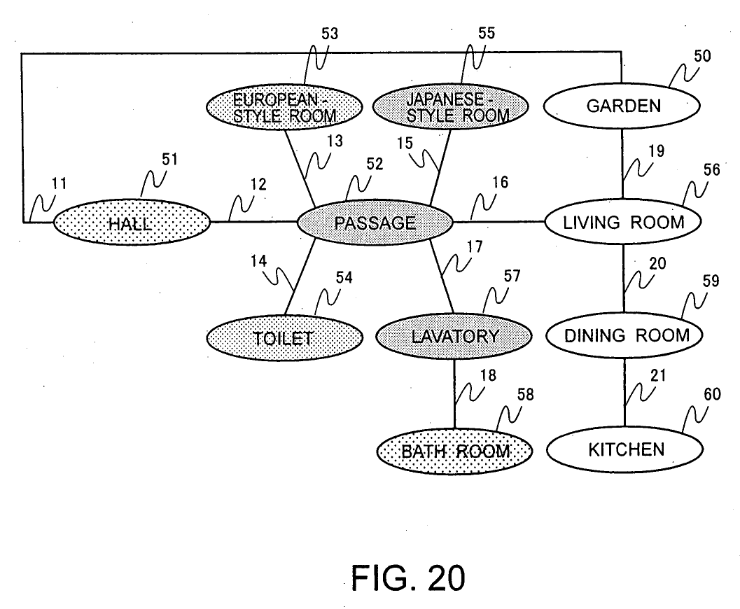

Assume that the user existence expected value is calculated based on the geometrical shape of each room. FIG. 20 is a schematic diagram of change of the user existence expected value of each room based on the passed time from the robot's missing the user. In the same way as in FIGS. 16, 17, and 18, the darker a color of the room is, the higher the user existence expected value of the room is. In FIG. 20, a moving distance from the passage 52 to the Japanese-style room 55 or the lavatory 57 is short, and the user existence expected value of these rooms is high. On the other hand, a moving distance from the passage 52 to the hall 51 is long, and the user existence expected value of this room is low. Furthermore, a moving distance from the lavatory 57 to the bath room 58 is short because area of the lavatory 57 is narrow. Accordingly, the user existence expected value of the bath room 58 is also calculated.

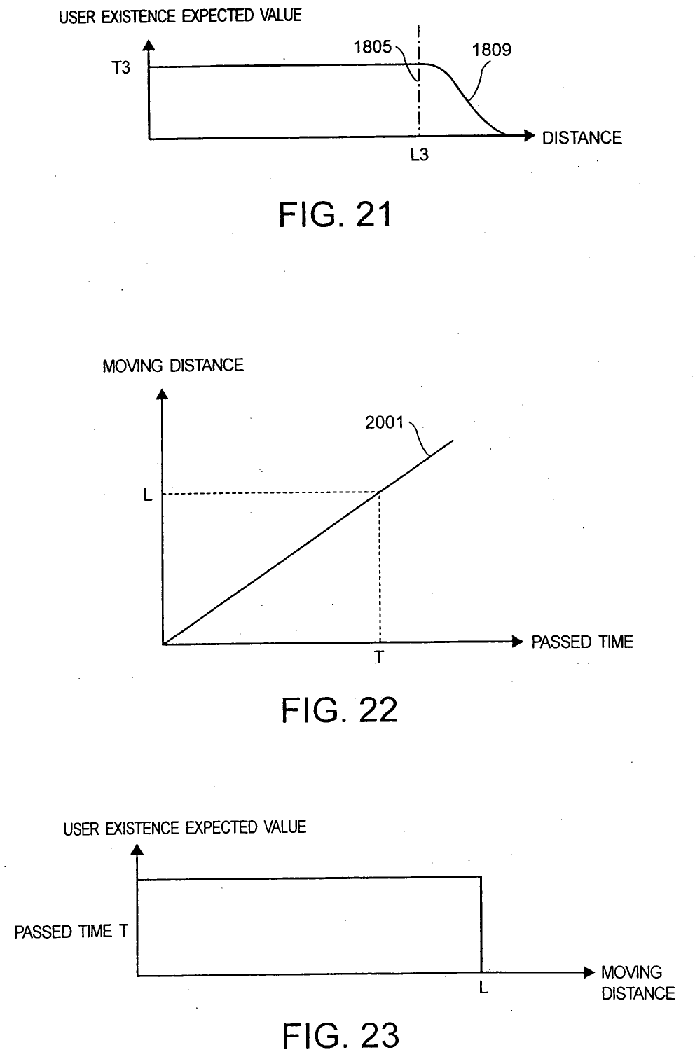

With the passage of time, at the passed time T3 in FIG. 19, a range before the maximum point 1805 of the user existence expected value on the distance axis, i.e., a distance shorter than L3 on the distance axis in FIG. 19, represents a distance of possibility that the user 2 exists. Accordingly, the expected value of the maximum point 1805 as the user existence expected value is assigned to the distance shorter than L3. On the other hand, a range after the maximum point 1805 on the distance axis, i.e., a distance longer than L3 on the distance axis in FIG. 19, a user moving expected value as the user existence expected value is assigned to the distance longer than L3. As a result, the user existence expected value at the passed time T3 is shown in FIG. 21.

From the time when the robot 1 last detected the user 2 from the doorway direction, the passed time is measured. Until the robot 1 detects the user 2 again in the user detection region 601 by tracking, user existence possibility based on the passed time is calculated as a distance function. The user existence possibility at the passed time based on a distance from the start room to another room is assigned to each room as the user existence expected value.

In order to simply calculate the user existence expected value, in case of the maximum of the user moving speed below a threshold, relationship between the passed time and the maximum user moving distance is shown in FIG. 22. In FIG. 22, a maximum of the user moving distance (the maximum user moving distance) is a straight line 2001 in proportion to the passed time. The maximum user moving distance L at arbitrary passed time T is guided from the straight line 2001, and it is predicted that the user 2 exists in distance range 0˜L at the passed time T. In this case, the user existence expected value is shown in FIG. 23. In FIG. 23, in the left side of distance L, the user existence expected value is a fixed positive value as a rectangle shape.

In the process of FIG. 10, if the geometrical user existable region does not exist, or if the detection unit 104 does not detect the user 2 in the geometrical user existable region, the user existable room prediction unit 113 calculates a product of the user existence expected value and an existence probability of each place (maximum existence probability in the room). The robot 1 moves to each place (room) in higher order of the product, and searches for the user 2 (S18). A path crossing a plurality of rooms is created as a general path on the movable room component data 1001. In each room, a local path connecting traversable doorways is created on the movable path data 1010. The robot 1 moves along the general path and the local path.

While the robot is moving, for example, when the detection unit 104 detects sound of a flush toilet or a shower, the robot 1 predicts the toilet 54 or the bath room 58 proper as a sound occurrence place (user's existing room), and sets this room as a moving target. In this case, the robot 1 need not search other rooms. Furthermore, while the robot is moving, when detection unit 4 detects the sound of open and shut of a door from the advance direction, the robot 1 need not search rooms except for the direction of the detected sound. In this way, by predicting a room where the user 2 exists, the robot 1 selects another traversable room (including the predicted room) having a path and nearest to the predicted room, and sets another traversable room as a moving target.

As mentioned-above, in the first embodiment, based on user position data representing the user's existence location/direction, user movable space data describing the user's movable space is created. Based on the user movable space, position relationship between the robot 1 and the user 2 is controlled. Briefly, the user movable space data is automatically created during the robot's working. Accordingly, ability to observe the user can automatically rise during the robot's working.

In the first embodiment, two type of search operation (geometrical user existable region and topological existable region) for the user 2 is executed based on the user's existable region (the movable path data 1010 and the movable room component data 1001). Accordingly, the user 2 can be effectively searched for in wide area.

In the first embodiment, a detection direction of the detection unit 104 is controlled along the predicted path along which the user will move. Accordingly, effect that the user is not missed is obtained.

In the first embodiment, a track path is created based on the robot's present location, the user's present location and direction, and the movable path data. By moving along the track path, the robot may track the user without missing. Furthermore, even if the user is missed, by predicting the user's moving path based on the user's last location, the robot can effectively search for the user.

In the first embodiment, an operation to detect the user's abnormality is executed based on the user's place on the movable place component data. Accordingly, abnormality can be adaptively detected based on the user's place.

In the first embodiment, expected value of the user's existence is calculated for the user's movable room (the user's destination), and the user can be effectively searched for based on the expected value of each room. Furthermore, the expected value is adequately calculated using a moving distance in each room based on geometrical shape of each room. Accordingly, the search is executed more effectively.

In the first embodiment, the adaptive microphone array unit 501 may specify the detection direction only, and is not limited to sound input from the detection direction. As control of the detection direction, in addition to the detection direction control unit, the detection direction may be controlled by operating a main body of the mobile robot 1. The present position localizing unit 109 may obtain the present position using a gyro and a pulse encoder. However, the present position may be obtained using ultrasonic waves and so on.

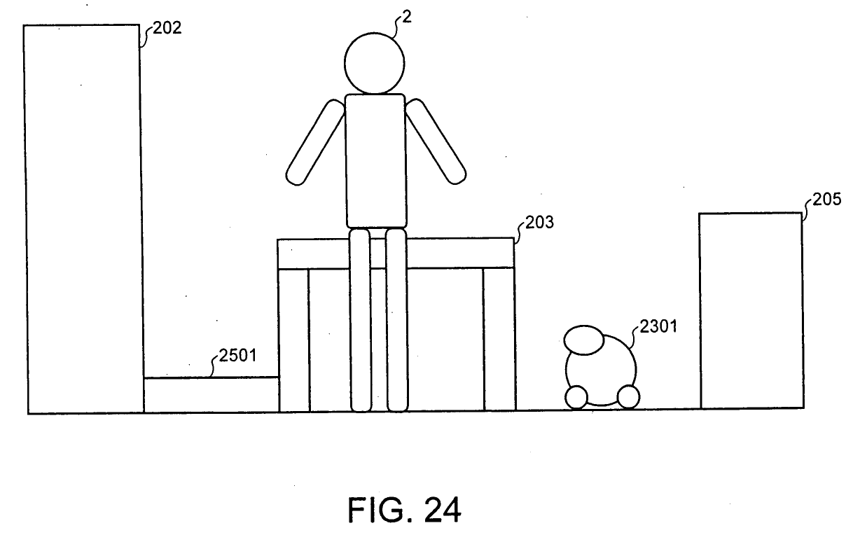

Next, a second embodiment of the present invention is explained referring to FIGS. 24˜32. As for units the same as in the first embodiment, the same number is assigned.

In the first embodiment, in case that the robot's movable space is matched with the user's movable space, the present invention is applied. However, in actual environment, an object having a height which the user can go across but the robot cannot traverse exists, and another object which the user avoids but which the robot passes under exists. Accordingly, in the mobile robot 1 of the second embodiment, in case that an object which the user can pass but the robot cannot move exists in the user movable region, a robot path to avoid the object is created.

FIG. 24 is an environment situation of the second embodiment. In FIG. 24, objects 202, 203, and 204, are the same as obstacles in FIG. 4. In the second embodiment, a cushion is added on the floor.

In this case, the cushion 2501 is not an obstacle to the user 2 because the user can go across it. A top board of the table 203 is an obstacle to the user because the user cannot go across it. On the other hand, the cushion 2501 and the legs of the table 203 are obstacles for the robot 2301, but the top board of the table 203 is not an obstacle for the robot because the robot can pass under the table 203. In this situation, if the robot 1 can move along an effective short cut course such as passing under the table than the user's moving path, the utility more increases.

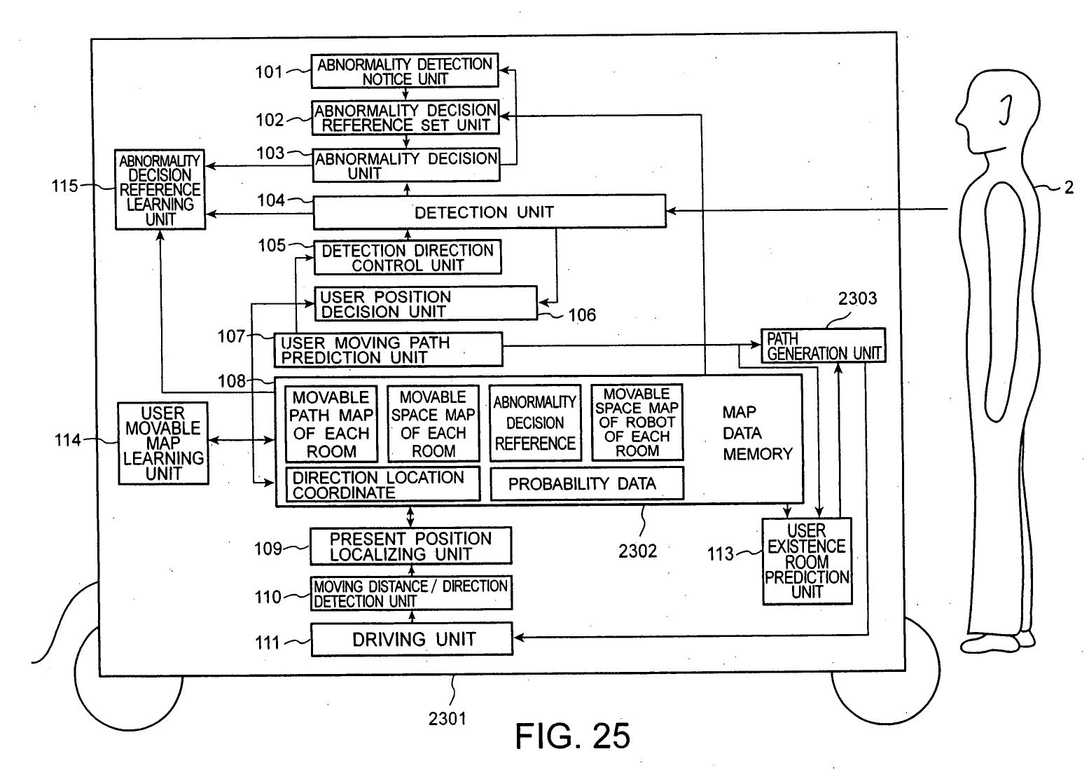

FIG. 25 is a block diagram of the mobile robot 2301 according to the second embodiment. In comparison to the first embodiment of FIG. 1, the map data memory 108 is changed to a map data memory 2302 storing different data, and the path generation unit 112 is changed to a path generation unit 2303 executing different processing.

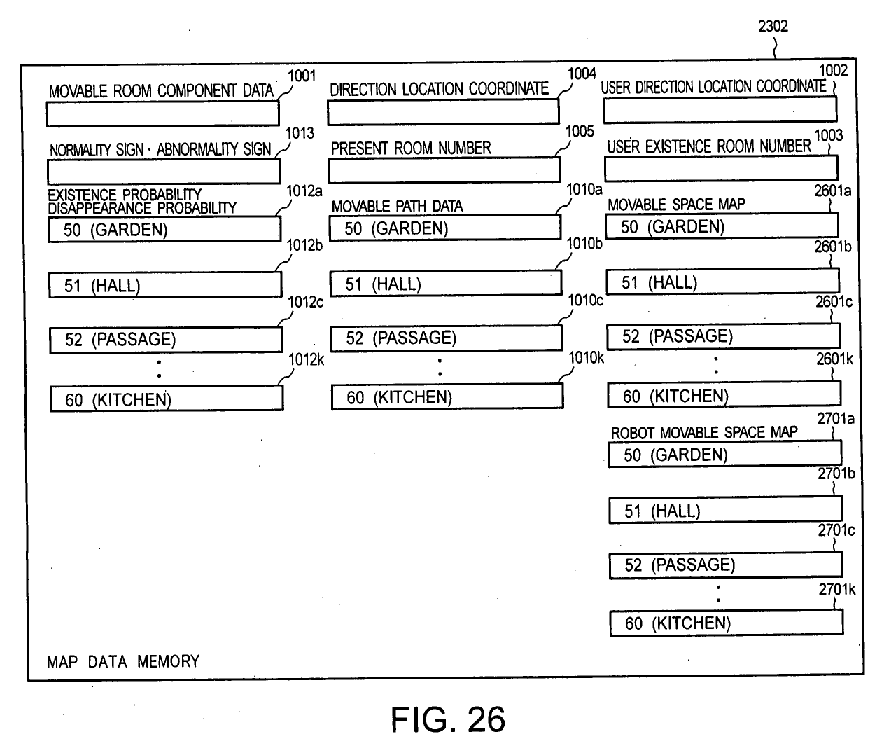

The map data memory 2302 stores a component map of a room, a map of each room, and a present position of the mobile robot 1 and the user 2. In this case, position means a location and a direction. FIG. 26 shows information stored in the map data memory 2302. The information includes movable room component data 1001, a movable space map 2601a˜k of each room, movable path data 1010a˜k of each room, a user direction location coordinate 1002, a user existence room number 1003, a direction location coordinate 1004, a present room number 1005, an existence probability/disappearance probability 1012a˜k of each room, normality sign/abnormality sign 1013 of each room, and robot movable space map 2701a˜k describing movable space map data of the robot 2301.

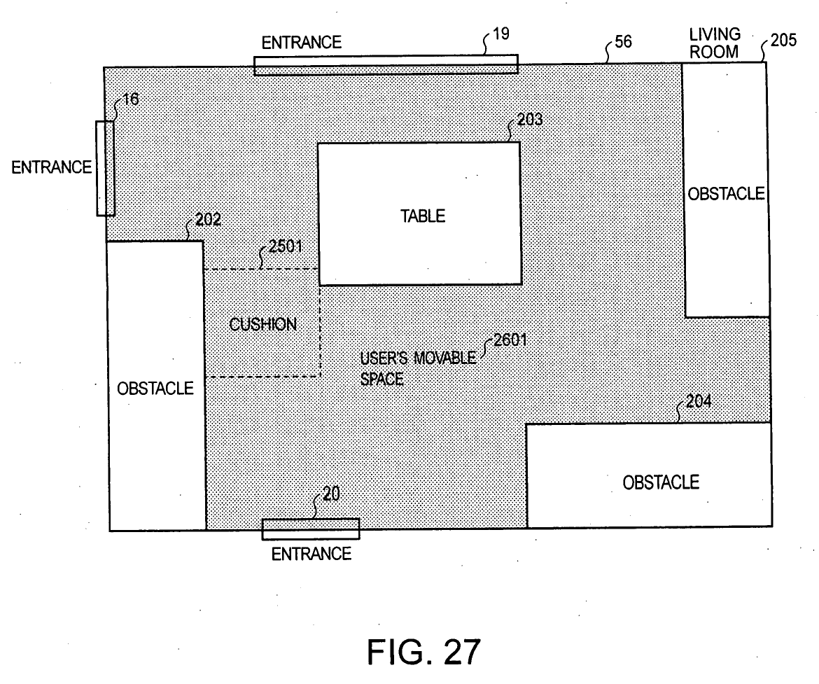

FIG. 27 shows a movable space map 2601 including the cushion 2501. The movable space map is created based on the user's movable space. The cushion 2501 is not an obstacle for the user 2 because the user 2 can go across it. The top board of the table 203 is an obstacle for the user 2. In this case, a movable space map 2601 is the same as the movable space map 1011 in FIG. 4.

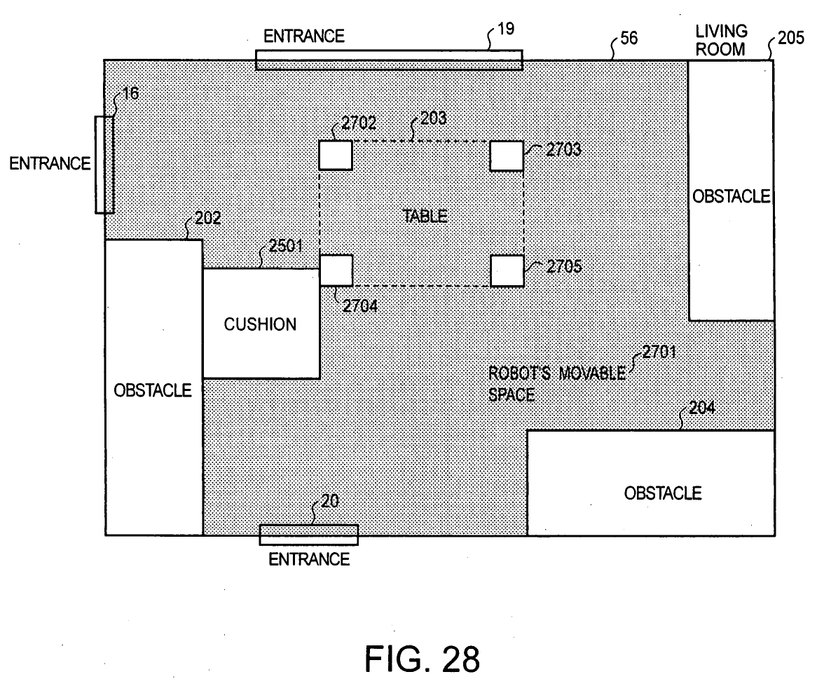

FIG. 28 shows a robot movable space map 2701 including the cushion 2501. The cushion 2501 and legs 2702˜2705 of the table 203 are obstacles for the robot 2301. However, the table 203 is not an obstacle for the robot 2301 because the robot 2301 can pass under the top board of the table 203.

All areas of the robot movable space map of each room are initially covered by obstacles. The mobile robot 2301 can move by detecting surrounding obstacles using a collision avoidance sensor. In this case, by describing a space in which obstacle is not detected on the movable space map, the robot's movable space is created as map data on the space of which all area is covered by obstacles. At start timing when the robot 2301 is operated, by wandering the robot 2301 freely, this map data is automatically created. Furthermore, after starting operation, in the same way as above steps, the robot 2301 can update the robot movable space map 2701.

The path generation unit 2303 generates a track path based on the present position of the robot 2301 and the movable path data 1010, and decides whether an obstacle which the robot 1 can not traverse exists based on the track path and the robot movable space map 2701. In case of deciding that the obstacle exists, the path generation unit 2303 generates an avoidant path to move the user's predicted path while a predetermined distance between the obstacle and the robot is kept.

Furthermore, as a path to search a predicted room where the user 2 will exist from the robot's present location, the path generation unit 2303 generates a general path from the movable room component data 1001, and a local path in each room from the movable path data 1010 and the robot movable space map 2701.

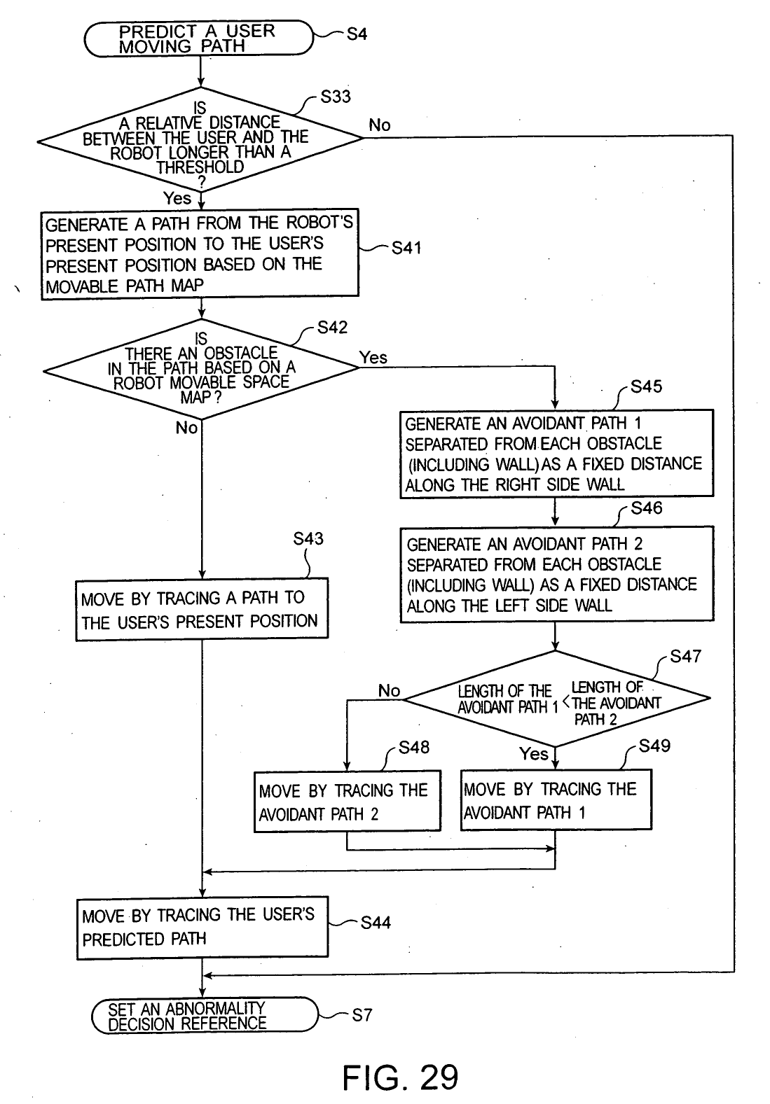

Next, processing of the mobile robot 2301 of the second embodiment is explained. In comparison with the first embodiment, a different step of the second embodiment is the user predicted path moving step S6 in FIG. 10. FIG. 29 is a flow chart of processing of the user predicted path moving step S6 according to the second embodiment.

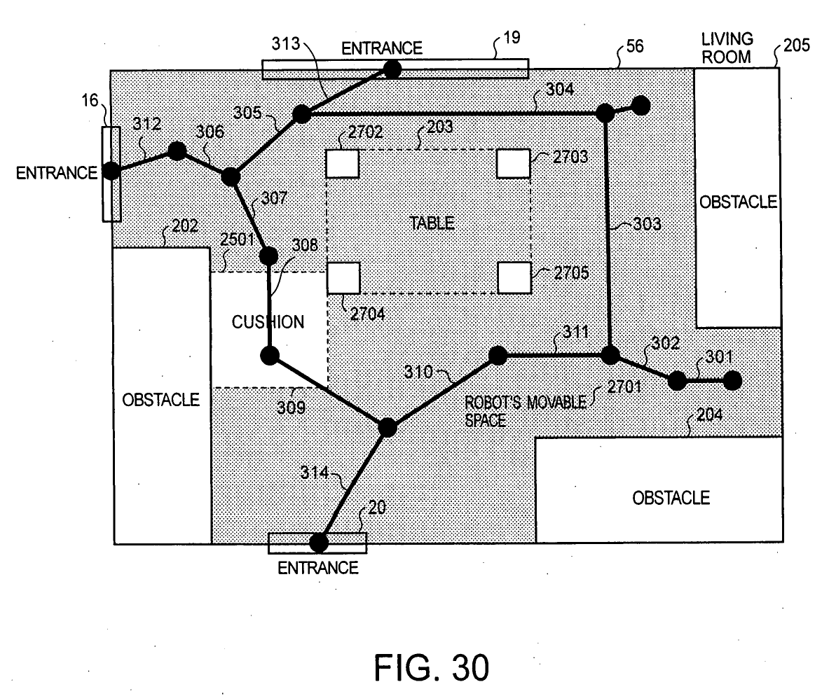

First, the detection unit 104 continually detects the user 2 in order not to miss the user 2 at the detection direction tracking step S5. It is decided whether a relative distance between the robot 2301 and the user 2 is longer than a threshold, based on coordinate data of the robot 2301 and the user 2 (S33). In case of deciding that the relative distance is longer, the path generation unit 2303 generates a track path from the robot's present location to the user's present location based on the movable path data (S41). Furthermore, it is decided whether an obstacle which the robot 2301 cannot traverse exists on the track path by comparing the track path with the robot movable space map 2701 (S42). This decision method is explained by referring to FIG. 30.

FIG. 30 is the robot movable space map 2701 on which the user's movable path data 1010 is overlapped. In FIG. 30, as the track path of the robot 2301, a path passing the user's segments 309 and 308 is the shortest. However, the path generation unit 2303 detects the cushion 2501 as the obstacle on the track path from the robot movable space map 2701, and decides that the robot 2301 cannot move along the track path. In this situation, an avoidant path is generated because the robot 2301 cannot traverse on the segments 309 and 308.

In case of deciding that the robot 2301 cannot move by the obstacle (Yes at S42), the path generation unit 2303 generates two kinds of avoidant paths from the robot's present position to the user's present position. One is, on the robot movable space map 2701 as the robot's movable space data, an avoidant path (generated at S45) distant from each obstacle (including a wall) as a fixed distance along the right side wall. The other is an avoidant path (generated at S46) distant from each obstacle (including a wall) as a fixed distance along the left side wall.

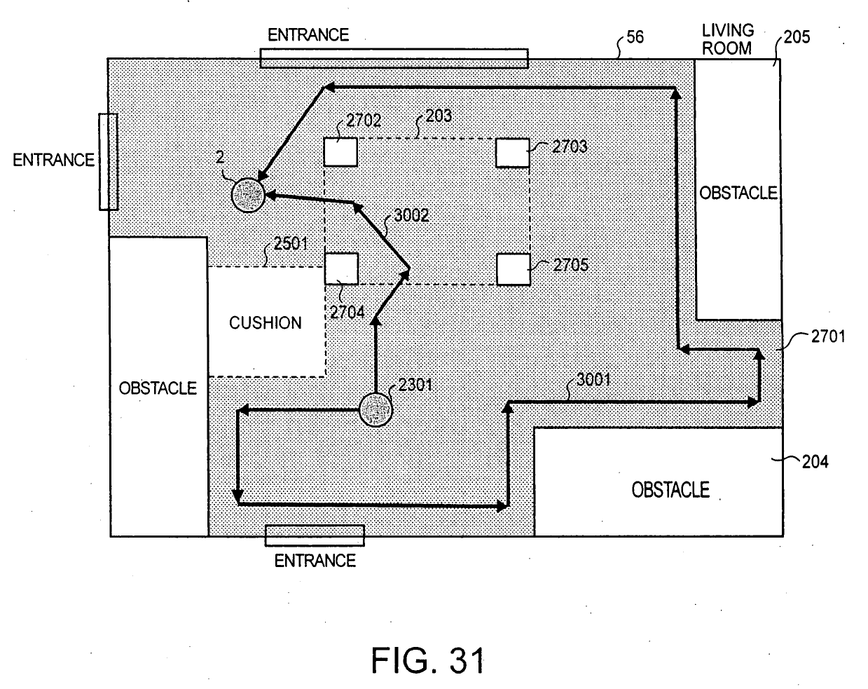

FIG. 31 shows the generated avoidant path data generated. The avoidant path 3001 represents a path from which each obstacle (including the wall) is located at the right side. The avoidant path 3002 represents a path from which each obstacle (including the wall) is located at the left side. In this case, on the avoidant path 3002, the top board of the table 203 is not an obstacle for the robot 2301. Briefly, a short cut course difference from the user's moving path is generated, and utility increases.

In FIG. 29, the path generation unit 2303 selects one avoidant path of which moving distance is shorter from two avoidant paths (S47). The driving unit 111 moves by tracing the one avoidant path (S48 or S49). In FIG. 31, the avoidant path 3002 is selected, and the robot 1 moves by tracing the avoidant path 3002.

In case of deciding that the obstacle does not exist (No at S42), the driving unit 111 moves from the robot's present position to the user's present position by tracing the track path (S43). After that, the robot 2301 moves by tracing the user predicted path (S44).

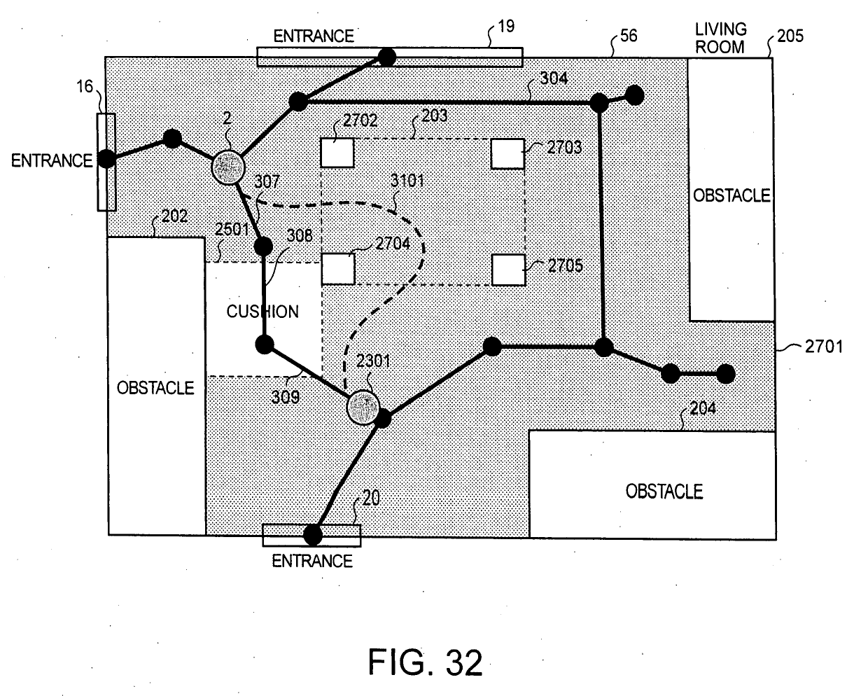

For example, as shown in FIG. 32, when the user 2 moves along a direction away from the robot 2301 on the segment 307, usually, the robot 2301 moves by tracking the segments 309, 308, and 307. However, as mentioned-above, the robot 2301 cannot move from the segment 309 to the segment 307 because of the cushion 2501. Accordingly, by generating an avoidant path 3101 guided from the segment 309 to the segment 307, the robot 2301 moves by tracing the avoidant path 3101.

In this way, even if the user 2 moves along a path on which only the user 2 can move, the robot 2301 tracks the user 2 by selecting the avoidant path. As a result, the utility further increases.

Furthermore, at the user movable path search step S15 and the inter-places moving search step S18, the avoidant path can be generated by the same method.

In the second embodiment, after deciding whether an object on the user's moving path is an obstacle for the robot based on a shape and a height of the object (measured by the detection unit 104), the robot movable space map 2701 as the robot's movable region is automatically generated. Furthermore, in the same way as in the first embodiment, the movable space map 1011 as the user's movable region is automatically generated by detecting the user's location and moving direction.

Briefly, an object having a height over which the robot cannot traverse, such as all area of a bureau and a cushion or the legs of a table, is regarded as an obstacle for the robot. An object existing within a predetermined height from a floor (a height over which the user cannot jump over, or below the user's height), such as the legs of the bureau and the table or the top board of table, is regarded as an obstacle for the user. Based on these obstacle data, the robot movable space map 2701 and the movable space map 2601 are generated.

As mentioned-above, in the mobile robot 2301 of the second embodiment, the robot movable space map 2701 representing a movable space for the robot 2301 is preserved. Accordingly, even if a place where the user 2 can move but the robot 2301 cannot move exists, the robot 2301 can track the user 2 without problem. Furthermore, by utilizing a space where the robot can move but the user cannot move, the avoidant path as a short cut course is generated, and the robot 2301 can effectively track the user.

Furthermore, in the second embodiment, based on robot position data representing the robot's existence location/direction, robot movable space data describing the robot's movable space is created. Based on the robot movable space, position relationship between the robot 2301 and the user 2 is controlled. Briefly, the robot movable space data is automatically created during the robot's working. Accordingly, ability to observe the user can automatically rise during the robot's working.

In the disclosed embodiments, the processing can be accomplished by a computer-executable program, and this program can be realized in a computer-readable memory device.

In the embodiments, the memory device, such as a magnetic disk, a flexible disk, a hard disk, an optical disk (CD-ROM, CD-R, DVD, and so on), an optical magnetic disk (MD and so on) can be used to store instructions for causing a processor or a computer to perform the processes described above.

Furthermore, based on an indication of the program installed from the memory device to the computer, OS (operation system) operating on the computer, or MW (middle ware software) such as database management software or network, may execute one part of each processing to realize the embodiments.

Furthermore, the memory device is not limited to a device independent from the computer. By downloading a program transmitted through a LAN or the Internet, a memory device in which the program is stored is included. Furthermore, the memory device is not limited to one. In the case that the processing of the embodiments is executed by a plurality of memory devices, a plurality of memory devices may be included in the memory device. The component of the device may be arbitrarily composed.

A computer may execute each processing stage of the embodiments according to the program stored in the memory device. The computer may be one apparatus such as a personal computer or a system in which a plurality of processing apparatuses are connected through a network. Furthermore, the computer is not limited to a personal computer. Those skilled in the art will appreciate that a computer includes a processing unit in an information processor, a microcomputer, and so on. In short, the equipment and the apparatus that can execute the functions in embodiments using the program are generally called the computer.

Other embodiments of the invention will be apparent to those skilled in the art from consideration of the specification and practice of the invention disclosed herein. It is intended that the specification and examples be considered as exemplary only, with the true scope and spirit of the invention being indicated by the following claims.

What is claimed is:

1. A mobile robot comprising:
a user position data acquisition unit configured to acquire user position data representing a user's position;
a user movable space generation unit configured to generate user movable space data representing a space in which the user moves based on the user position data; and
a position relationship control unit configured to control a position relationship between the user and the mobile robot based on the user movable space data.

2. The mobile robot according to claim 1, further comprising:
a robot position data acquisition unit configured to acquire robot position data representing the robot's position; and
a robot movable space generation unit configured to generate robot movable space data representing a space in which the robot moves based on the robot position data;
wherein said position relationship control unit controls a position relationship between the user and the robot based on the robot movable space data.

3. The mobile robot according to claim 1, further comprising:
an abnormality decision unit configured to decide an abnormal status of the user.

4. The mobile robot according to claim 1, wherein
said user movable space generation unit calculates an existence probability based on the user's staying time at the same position, and correspondingly adds the existence probability to the user movable space data, and
said position relationship control unit controls the position relationship based on the existence probability.

5. The mobile robot according to claim 1, wherein
said user movable space generation unit calculates a disappearance probability based on a number of disappearance occurrences of the user at the same position, and correspondingly adds the disappearance probability to the user movable space data, and
said position relationship control unit controls the position relationship based on the disappearance probability.

6. The mobile robot according to claim 3, further comprising:
an abnormality decision reference learning unit configured to generate normality sign data as feature data in observation signal during the user's normal status; and
an abnormality decision reference set unit configured to set an abnormality decision reference to decide the user's abnormal status based on the normality sign data.

7. The mobile robot according to claim 3, further comprising:
an abnormality decision reference learning unit configured to generate abnormality sign data as feature data in observation signal during the user's abnormal status; and
an abnormality decision reference set unit configured to set an abnormality decision reference to decide the user's abnormal status based on the abnormality sign data.

8. The mobile robot according to claim 1,
wherein said user movable space generation unit locates a predetermined figure at the user's position on a space map, sets an area covered by the figure as the user's occupation space, and sets the sum of the user's occupation space based on the user's moving as the user movable space data.

9. The mobile robot according to claim 1,
wherein said position relationship control unit searches for and tracks the user based on the user movable space data.

10. The mobile robot according to claim 2,
wherein said position relationship control unit searches for and tracks the user based on the robot movable space data.

11. The mobile robot according to claim 1, further comprising:
a map data memory configured to store movable room component data having a plurality of rooms interconnected by a plurality of links as a doorway of each room, a traversable flag being added to each link and an entrance flag being added to each room, and
a user existence room prediction unit configured to predict a user's location based on the movable room component data and the user's previous position;
wherein said position relationship control unit controls the robot to move to the user's predicted location.

12. The mobile robot according to claim 1, further comprising:
a user moving path prediction unit configured to generate user movable path data based on the user movable space data and the user's present location, and predict a user's moving path based on the user movable path data,
wherein said position relationship control unit controls the robot to move along the user's predicted moving path.

13. The mobile robot according to claim 6,
wherein said abnormality decision unit decides the user's abnormal status by not detecting the normality sign data over a predetermined period.

14. The mobile robot according to claim 7,
wherein said abnormality decision unit decides the user's abnormal status by detecting abnormality sign data.

15. The mobile robot according to claim 6, wherein,
when the normality sign data is not detected after detecting previous normality data,
said abnormality decision reference learning unit starts recording the observation signal detected from a position where the normality sign data is begun to be not detected, and
when the normality sign data is detected again within a predetermined period from a start time of recording,
said abnormality decision reference learning unit generates new normality sign data from the observation signal recorded, and corresponds the new normality sign data with the position in the user movable space data.

16. The mobile robot according to claim 6, wherein,
when the normality sign data is not detected after detecting previous normality data,
said abnormality decision reference learning unit starts recording the observation signal detected from a position where the normality sign data is begun to be not detected, and
when the normality sign data is not continually detected over a predetermined period from a start time of recording,
said abnormality decision reference learning unit generates abnormality sign data from the observation signal recorded, and corresponds the abnormality sign data with the position in the user movable space data.

17. A method for controlling a mobile robot, comprising:
acquiring user position data representing a user's position;
generating user movable space data representing a space in which the user moves based on the user position data; and
controlling a position relationship between the user and the mobile robot based on the user movable space data.

18. The method according to claim 17, further comprising:
acquiring robot position data representing the robot's position;
generating robot movable space data representing a space in which the robot moves based on the robot position data; and
controlling a position relationship between the user and the robot based on the robot movable space data.

19. A computer program product, comprising:
a computer readable program code embodied in said product for causing a computer to control a mobile robot, said computer readable program code comprising:
a first program code to acquire user position data representing a user's position;
a second program code to generate user movable space data representing a space in which the user moves based on the user position data; and
a third program code to control a position relationship between the user and the mobile robot based on the user movable space data.

20. The computer program product according to claim 19, further comprising:
a fourth program code to acquire robot position data representing the robot's position;
a fifth program code to generate robot movable space data representing a space in which the robot moves based on the robot position data; and
a sixth program code to control a position relationship between the user and the robot based on the robot movable space data.
